(19) United States
(12) Patent Application Publication
(10) Pub. No.: US 2025/0226401 A1
(43) Pub. Date: Jul. 10, 2025

(54) IRON POWDER, IRON ELECTRODE, IRON BATTERY, AND METHOD OF MANUFACTURE THEREOF

(71) Applicant: Form Energy, Inc., Somerville, MA (US)

(72) Inventors: Leah Nation, Cambridge, MA (US); Rebecca Marie Eisenach, Cambridge, MA (US); Thomas Conry, San Diego, CA (US); Kasey Devlin, Pittsburgh, PA (US); Michael Ickes, Homestead, PA (US); Valerie Christine Sacha, Cambridge, MA (US); Michael Gibson, Somerville, MA (US); Nicholas Perkins, Emeryville, CA (US)

(73) Assignee: Form Energy, Inc., Somerville, MA (US)

(21) Appl. No.: 19/002,307

(22) Filed: Dec. 26, 2024

Related U.S. Application Data
(60) Provisional application No. 63/617,628, filed on Jan. 4, 2024.
(60) Provisional application No. 63/722,405, filed on Nov. 19, 2024.

(51) Int. Cl. H01M 4/38; H01M 4/02; H01M 4/04; H01M 4/48

(52) U.S. Cl. CPC H01M 4/38; H01M 4/049; H01M 4/483; H01M 2004/021; H01M 2220/10; H01M 2300/0025

(57) ABSTRACT

An electrode, including a first iron material and a second iron material. The first iron material is a first reduced iron and the second iron material is different from the first iron material. Also provided is an electrochemical cell comprising an electrode including a first iron material and a second iron material. Further provided is a method of making an electrode.

### CROSS REFERENCE TO RELATED APPLICATIONS

This application claims priority to and the benefit of U.S. Provisional Patent Application No. 63/617,628, filed Jan. 4, 2024 and of U.S. Provisional Patent Application No. 63/722,405, filed Nov. 19, 2024 in the United States Patent and Trademark Office, and all the benefits accruing therefrom under 35 U.S.C. § 119, the contents of which in their entirety are hereby incorporated by reference.

### BACKGROUND

Energy storage technologies provide an increasingly important role in electric power grids. For example, energy storage systems can improve matching of power generation and demand on a power grid. Notable is the ongoing need for energy storage technologies that can power a grid for hours to days.

Iron-containing negative electrode electrochemical systems are attractive options for grid-scale electrochemical energy storage. However, it can be difficult to achieve high performance in iron-containing negative electrodes, especially at lower discharge rates, such as discharge rates associated with full discharge times of greater than about 8 hours. Direct Reduced Iron (“DRI”) is a promising material for an iron-containing negative electrode, however electrodes fabricated from DRI can face challenges in realizing performance increases, despite other promising material properties of DRI. Sponge iron is another promising candidate for iron-containing negative electrodes, however electrodes fabricated from sponge iron can be expensive.

Accordingly, there remains a continuing need for improved iron-containing negative electrode materials for use in electrochemical energy storage.

### SUMMARY

Disclosed is an electrode including a first iron material, wherein the first iron material is a first reduced iron; and a second iron material that is different from the first iron material.

Also disclosed is an electrochemical cell including a first electrode; a second electrode; and an electrolyte disposed between the first electrode and the second electrode. At least one of the first electrode or the second electrode includes a first iron material, wherein the first iron material is a first reduced iron; and a second iron material that is different from the first iron material. Optionally the first electrode is prepared from a composition including the first iron material, the second electrode is prepared from a composition including the second iron material, or both.

Also disclosed is a method of preparing an electrode. The method includes providing a blend of a first iron material and a second iron material, wherein the first iron material is a first reduced iron, and the second iron material that is different from the first iron material; and forming the first blend into the electrode including a second blend. A surface area of the first blend is less than a surface area of the second blend.

Also disclosed is a method of forming an active material for an electrode. The method includes providing an iron material and an additive and forming the iron material and the additive into the active material. The forming comprises atomizing the iron material and the additive.

Also disclosed is an electrochemical cell, including a first electrode; a second electrode; and an electrolyte disposed between the first electrode and the second electrode. At least one of the first electrode or the second electrode comprises the active material prepared by the method of forming an active material for an electrode.

Also disclosed is a method of forming an electrode. The method includes providing an initial iron material having a first apparent density and a first surface area; oxidizing the initial iron material to form an oxidized iron material; reducing the oxidized iron material to form an iron material, and forming the iron material into the electrode. The iron material has a second apparent density and a second surface area, wherein the second apparent density is less than the first apparent density, and the second surface area is greater than the first surface area.

### BRIEF DESCRIPTION OF THE DRAWINGS

The following figures are exemplary embodiments wherein the like elements are numbered alike.

FIG. 1 is a schematic cross-sectional view of an embodiment of an electrochemical cell;

FIG. 2 is a photographic image of series of electrodes prepared in accordance with Example 1;

FIGS. 3A and 3B are graphs of discharge capacity (milliampere hours per gram, mAh/g) versus cycle (number) for the electrochemical cells prepared in accordance with Example 2 at temperatures of 30° C. and 45° C., respectively;

FIG. 4 is a graph of average discharge voltage (V, volts) versus cycle (number) for the electrochemical cells prepared in accordance with Example 3;

FIG. 5A is a graph of average hardness (Shore D Hardness) versus particle size (percent fines, particles having a D50 of less than 180 micrometers) in accordance with Example 3;

FIG. 5B is a graph of mass loss per stroke (grams per stroke) versus particle size (percent fines, particles having a D50 of less than 180 micrometers) in accordance with Example 3;

FIG. 6A is a graph of discharge capacity (mAh/g) versus cycle (number) in accordance with Example 4;

FIG. 6B is a graph of discharge voltage (V) versus cycle (number) in accordance with Example 4;

FIG. 7 is a photographic image of a series of electrodes prepared in accordance with Example 5;

FIG. 8 is a graph of total discharge capacity (mAh/g) versus cycle (number) in accordance with Example 5;

FIG. 9 is a table showing the properties of the iron powders in accordance with Example 6;

FIG. 10A is a Scanning Electron Micrograph (SEM) showing the iron powder product prepared by oxidation at 12 hours at 300° C. and reduction at 1050° C. for 2 hours in accordance with Example 6; and

FIG. 10B is an SEM showing the iron powder product prepared by room temperature oxidation in a brine solution for 40 hours and reduction at 700° C. for 2 hours in accordance with Example 6.

### DETAILED DESCRIPTION

Metal-air batteries are electrochemical cells that include a metal-containing negative electrode, a positive electrode that is exposed to air (also referred to as an air electrode), and an aqueous or aprotic or solid state electrolyte. During discharge, oxygen from air is reduced at the positive electrode, and the metal of the negative electrode is oxidized. Recently, interest in developing iron-air batteries has increased because iron-air batteries may be able to provide economical grid-scale energy storage. In addition, the primary raw material of iron-air batteries is iron oxide, which is an abundant, inexpensive, non-toxic, and economical material.

While not wanting to be bound by theory, it is understood that half-cell reactions at an iron negative electrode that occur during discharge and oxidation in an alkaline electrolyte are as provided by Equations 1 and 2:

Fe+2OH⁻⇄Fe(OH)₂+2e⁻ (Equation 1)

3Fe(OH)₂+2OH⁻⇄Fe₃O₄+4H₂O+2e⁻ (Equation 2)

While not wanting to be bound by theory, it is understood that according to Equation 1, iron hydroxide is formed on the surface of iron metal of the iron electrode. According to Equation 2, the iron hydroxide is subsequently oxidized to form magnetite. There is a net volume increase upon discharge that is taken up in the porosity of the iron electrode. The theoretical capacity, starting from metallic iron, is 960 milliampere hours per gram of iron (mAh/g Fe) for Equation 1, and 320 mAh/g Fe for Equation 2.

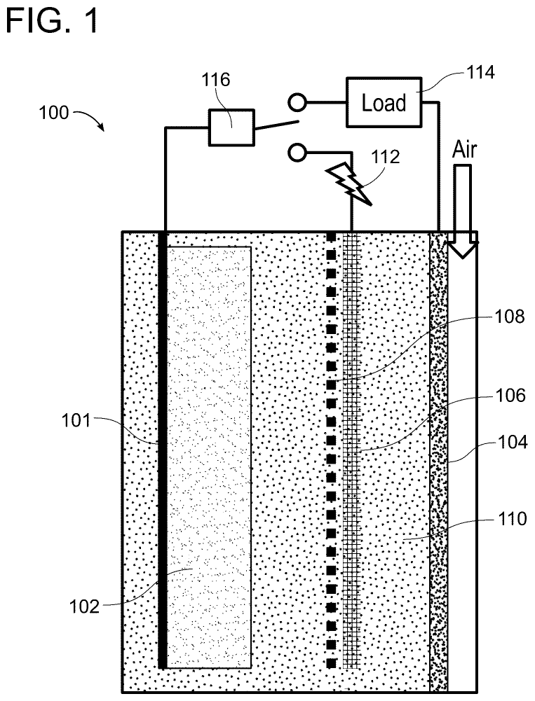

An embodiment of an iron-air electrochemical cell is shown in FIG. 1, which includes a dual-electrode configuration. As used herein, the term “dual-electrode configuration” refers to an iron-air battery having separate positive electrodes for charging and discharging. When oxygen is the reactant at the positive electrode, it can be advantageous to have separate electrodes for discharging and for charging. Referring to FIG. 1, an electrochemical cell 100 is provided. The iron-air cell 100 includes a current collector 101, an iron electrode 102 (negative electrode) disposed on the current collector 101, an oxygen reduction reaction (ORR) electrode 104, and an oxygen evolution reaction (OER) electrode 106. The iron-air cell 100 may further include a separator 108 that is disposed between the iron electrode 102 and the OER electrode 106. The separator 108 may include a compression frame, a porous insulator, and/or a ribbed structure to facilitate bubble egress from the iron electrode 102. For example, the separator 108 may be a porous dielectric coating formed on the iron electrode 102 and/or the OER electrode 106. The iron-air electrochemical cell further includes an electrolyte 110 that is in contact with the iron electrode, a first surface of the ORR electrode 104, and the OER electrode 106. Suitable electrolytes are further described herein.

During charge of the iron-air electrochemical cell 100, the OER electrode 106 and the iron electrode 102 may be electrically connected to a power source 112, such that an iron species of the iron electrode 102 is reduced to form metallic iron, Fe(0). During discharge of the iron-air electrochemical cell 100, the ORR electrode 104 and the iron electrode 102 may be electrically connected to a load 114, such that metallic iron Fe(0) of the iron electrode 102 is oxidized to form higher valence iron species such as Fe₃O₄. The iron-air electrochemical cell 100 may be further configured to include a switch 116 to allow electrical connection between the iron electrode 102 and the power source 112, or to allow electrical connection between the iron electrode 102 and the load 114.

High performing, long-lived iron-containing iron electrodes have many desirable attributes, including high purity iron or iron-containing materials, good mechanical and electrical durability, sufficient surface area or porosity to enable reversible electrochemical reactions to occur and for the products of electrochemical reactions to be stored, and suitable cost and scale for mass production. It can be difficult to achieve all of these properties together in an iron-containing electrode. Many commercially available types of iron and iron oxide materials have insufficient surface area or have too high of a packing density for suitable electrochemical cell charge or discharge rate, or to provide suitable performance early in their operational lifespan.

The present inventors have discovered that iron electrodes having improved properties may be prepared from a blend of two or more different iron-containing materials, as described herein. The iron-containing materials may be of similar or different apparent densities, particle size distributions, surface areas, and/or chemical constituents (including both impurities and oxidation states). By blending different iron-containing materials together, an unexpected synergistic improvement to properties, such as mechanical durability and performance, is observed.

In another aspect, a method is also provided for producing an iron powder containing desirable additives through an atomization process. As provided herein, aspects provide for the production of an electrode by an atomization process, where molten iron may be atomized with a gas or water source, for example. Molten metal additives may be added to the iron stream as a means of producing high performance electrode materials. Such materials may be used as an iron material of an electrode in the electrochemical cells described herein.

In still other aspects, a method is provided for providing high density, low surface area iron powder by oxidizing and reducing the material to provide an iron powder product having reduced apparent density and increased surface area. Such materials may be used as an iron material of an electrode in the electrochemical cells described herein.

Provided is an electrode that includes a first iron material, wherein the first iron material is a first reduced iron; and a second iron material that is different from the first iron material. For example, the electrode may include an active material that includes a composition including the first iron material and the second iron material as described herein. In some embodiments, the electrode may be a negative electrode suitable for an iron-air battery.

The electrode may include 5 to 95 weight percent (wt %) of the first iron material, and 5 to 95 wt % of the second iron material, each based on a total weight of the electrode. In some embodiments, the electrode may include 10 to 75 wt % of the first iron material, and 25 to 90 wt % of the second iron material, each based on a total weight of the electrode. In still other embodiments, the electrode may include 10 to 50 wt % of the first iron material, and 50 to 90 wt % of the second iron material, each based on a total weight of the electrode. In an aspect, a content of the first iron material may be 5, 10, 15, 20, 25, 30, 35, 40, 45, 50, 55, 65, 70, 75, 80, 85, 90 wt % to 10, 15, 20, 25, 30, 35, 40, 45, 50, 55, 65, 70, 75, 80, 85, 90, or 95 wt %, based on a total weight of the electrode, wherein the endpoints are independently combinable. Also, a content of the second iron material may be 5, 10, 15, 20, 25, 30, 35, 40, 45, 50, 55, 65, 70, 75, 80, 85, 90 wt % to 10, 15, 20, 25, 30, 35, 40, 45, 50, 55, 65, 70, 75, 80, 85, 90, or 95 wt %, based on a total weight of the electrode, wherein the endpoints are independently combinable. In an aspect, the electrode consists of the first iron material and the second iron material, and thus a sum of the content of the first iron material and the second iron material may be 100 wt %.

The first iron material may have a D50 particle size of less than 45 micrometers (μm), 40 to 700 μm, preferably 120 to 450 μm, more preferably 120 to 450 μm. The first iron material may have a D50 particle size of 5, 40, 60, 80, 100, 125, 150, 175, 200, 300, or 400 μm to 40, 60, 80, 100, 125, 150, 175, 200, 300, 400, 500, 600, or 700 μm, wherein the endpoints are independently combinable. For example, the D50 particle size of the first iron material may be 5 to 40 μm, 40 to 125, or the like.

The first iron material may have an apparent density of 0.5 to 3.5 grams per cubic centimeter (g/cm³), preferably 0.8 to 2.0 g/cm³. The first iron material may have an apparent density of 0.1, 0.2, 0.3, 0.4, 0.5, 0.6, 0.7, 0.8, 1, 1.5, 2, 3, 4, 5, 6, or 7 g/cm³ to 0.2, 0.3, 0.4, 0.5, 0.6, 0.7, 0.8, 1, 1.5, 2, 3, 4, 5, 6, 7, or 7.5 g/cm³, wherein the endpoints are independently combinable.

In some embodiments, the first iron material may be a first atomized iron, a first sponge iron or a first Direct Reduced Iron (DRI). In some embodiments, the first iron material does not comprise an iron oxide, for example, the first iron material may comprise less than 0.1 wt % of an iron oxide based on a total weight of the first iron material. As used herein, “direct reduced iron” refers to an iron material different from sponge iron that is produced from, or obtained from the reduction of a natural or processed iron ore, such reduction being conducted without reaching the melting temperature of iron. In various embodiments the iron ore may comprise taconite, magnetite, hematite, goethite, or a combination thereof. In various embodiments, the DRI may be in the form of pellets, which may be spherical or substantially spherical. In various embodiments the DRI may be porous, containing open and/or closed internal porosity. In various embodiments the DRI may comprise materials that have been further processed by hot or cold briquetting. In various embodiments, the DRI may be produced by reducing iron ore pellets to form a more metallic (more reduced, less oxidized) material, such as iron metal (Fe⁰), wustite (FeO), or a composite pellet comprising iron metal and a residual oxide phase. In some embodiments, the DRI may be reduced iron ore taconite, direct reduced (“DR”) taconite, reduced “Blast Furnace (BF) Grade” pellets, reduced “Electric Arc Furnace (EAF)-Grade” pellets, “Cold Direct Reduced Iron (CDRI)” pellets, direct reduced iron (“DRI”) pellets, Hot Briquetted Iron (HBI), or a combination thereof. In some embodiments, the iron in the DRI is fully reduced to Fe⁰.

As used herein, “sponge-iron” is a three-dimensional porous material made primarily of reduced iron. Sponge iron may be a material formed by solid-state reduction of iron resulting in an iron-containing structure that has a greater porosity than prior to reduction. The sponge iron may be made from iron ore, or may be produced from any suitable oxygen containing iron material or Fe-O species that may be reduced to form a porous structure. Such feedstocks may include mill scale, an acid-digested and optionally purified iron feedstocks, sinter feed, ore, processed ore, or any other suitable Fe-O species for reduction to form a structure with increased porosity. The sponge iron preferably has an apparent density less than a density of iron, more preferably less than 7.8 grams per cubic centimeter (g/cm³), less than 7.5 g/cm³, less than 7 g/cm³, less than 6 g/cm³, less than 5 g/cm³, less than 4 g/cm³, less than 3.5 g/cm³, less than 3 g/cm³, or less than 2.5 g/cm³. In an aspect, the sponge iron has an apparent density greater than 0.1, 0.5, or 1 g/cm³.

In some embodiments, the second iron material includes an electrolytic iron, a carbonyl iron, an iron oxide, a second reduced iron, or a combination thereof. The second reduced iron may comprise a second atomized iron, a second direct reduced iron, or a combination thereof.

As used herein, “atomized iron” refers to an iron material that is prepared by an atomizing method. As the atomization method, any of a water atomizing method, a gas atomizing method, a granulation method, or the like may be use. In some embodiments, the second iron material may include an atomized iron. For example, the atomized iron may be water atomized iron, gas atomized iron, or granulated iron.

In some embodiments, the second iron material may include an iron oxide. For example, the iron oxide may include hematite, magnetite, maghemite, wustite, martite, goethite, limonite, siderite, pyrite, ilmenite, spinel manganese ferrite, or a combination thereof.

In an aspect, the second iron material has a D50 particle size that is less than the D50 particle size of the first iron material. The second iron material may have a D50 particle size of 5 to 500 micrometers, preferably 20 to 400 micrometers. The second iron material may have a D50 particle size of 5, 10, 25, 50, 60, 80, 100, 125, 150, 175, 200, 300, or 400 μm to 10, 25, 50, 60, 80, 100, 125, 150, 175, 200, 300, 400, 500, 600, or 700 μm, wherein the endpoints are independently combinable.

In an aspect, the second iron material has an apparent density that is less than the apparent density of the first iron material. The second iron material may have an apparent density of 0.5 to 4 grams per cubic centimeter. The second iron material may have an apparent density of 0.1, 0.2, 0.3, 0.4, 0.5, 0.6, 0.7, 0.8, 1, 1.5, 2, 3, or 4 g/cm³ to 0.2, 0.3, 0.4, 0.5, 0.6, 0.7, 0.8, 1, 1.5, 2, 3, 4, to 5 g/cm³, wherein the endpoints are independently combinable.

In some embodiments, the second iron material may include a second atomized iron, wherein the second iron material has a D50 particle size of 10 to 250 micrometers (μm), 50 to 120 μm, preferably 20 to 150 μm, more preferably 25 to 70 μm; an apparent density of 0.5 to 3.8 g/cm³, preferably 1.8 to 3.2 g/cm³; or a combination thereof.

In some embodiments, the second iron material may include a second reduced iron, wherein the second reduced iron has a D50 particle size of 5 to 500 μm, preferably 150 to 300 μm; an apparent density of 0.5 to 3.2 g/cm³, preferably 0.5 to 1.8 g/cm³; or a combination thereof.

In some embodiments, the second iron material may include an iron oxide, wherein the iron oxide has a D50 particle size of 10 to 500 μm, 50 to 300 μm, preferably 35 to 210 μm, more preferably 35 to 150 μm.

In some embodiments, the electrode may further include an additive. Exemplary additives may include, for example, copper, lead, bismuth, indium, tin, aluminum, an alloy thereof, or a combination thereof. When an additive is present, the additive may be included in an amount of 0.001 to 10 wt %, preferably 0.1 to 5 wt %, based on a total weight of the electrode.

In still other embodiments, the electrode may further include a third iron material, wherein the third iron material is different from the first iron material and the second iron material. For example, the third iron material may include an electrolytic iron, a carbonyl iron, an iron oxide, a third reduced iron, or a combination thereof. The third reduced iron may comprise a third atomized iron, a third direct reduced iron, or a combination thereof.

In some embodiments, the electrode may include the third iron material, wherein the electrode includes 5 to 90 wt % of the first iron material, 5 to 90 wt % of the second iron material, and 5 to 90 wt % of the third iron material, each based on a total weight of the electrode. For example, the electrode may include 10 to 70 wt % of the first iron material, 15 to 80 wt % of the second iron material, and 15 to 80 wt % of the third iron material, each based on a total weight of the electrode. Preferably, the electrode may include 10 to 50 wt % of the first iron material, 25 to 75 wt % of the second iron material, and 25 to 75 wt % of the third iron material, each based on a total weight of the electrode. In an aspect, each of the first iron material, the second iron material, and the third iron material may each independently be contained in an amount of 5, 10, 15, 20, 25, 30, 35, 40, 45, 50, 55, 65, 70, 75, 80, 85, 90 wt % to 10, 15, 20, 25, 30, 35, 40, 45, 50, 55, 65, 70, 75, 80, 85, 90, or 95 wt %, based on a total weight of the electrode, wherein the endpoints are independently combinable. In an aspect, the electrode consists of the first iron material, the second iron material, and the third iron material, and thus a sum of the content of the first iron material, the second iron material, and the third iron material may be 100 wt %.

In some embodiments, the third iron material may have a D50 particle size of 5 to 850 micrometers. The third iron material may have a D50 particle size of 5, 25, 50, 100, 200, 300, or 400 μm to 25, 50, 100, 200, 300, 400, 500, 600, 700, or 850 μm, wherein the endpoints are independently combinable. In some embodiments, the third iron material has an apparent density of 0.5 to 4 grams per cubic centimeter (g/cm³), e.g., 0.5, 0.6, 0.7, 0.8, 1, 1.5, 2, or 3 g/cm³ to 0.6, 0.7, 0.8, 1, 1.5, 2, 3, or 4 g/cm³, wherein the endpoints are independently combinable.

In some embodiments, the third iron material is an atomized iron. For example, the third iron material may be water atomized iron, gas atomized iron, or granulated iron.

In some embodiments, the third iron material may include a second iron oxide. Exemplary iron oxides include hematite, magnetite, maghemite, wustite, martite, goethite, limonite, siderite, pyrite, ilmenite, spinel manganese ferrite, or a combination thereof.

In some embodiments, the electrode may include
(i) a sponge iron, an atomized iron, and an iron oxide;
(ii) a sponge iron, an iron oxide, and an additive;
(iii) a first sponge iron, a second sponge iron, and a third atomized iron, wherein the first sponge iron is different from the second sponge iron;
(iv) a first sponge iron, a second sponge iron, and a second iron oxide, wherein the first sponge iron is different from the second sponge iron;
(iv) a sponge iron, a second atomized iron, and a third atomized iron, wherein the second atomized iron is different from the third atomized iron; or
(v) a first sponge iron, a first iron oxide, and a second iron oxide, wherein the first iron oxide is different from the second iron oxide.

In some embodiments, the electrode may further include a current collector. The current collector may be in the form of a metal plate, and may comprise iron, nickel, stainless steel, nickel-plated stainless steel, or the like. The current collector may be porous or nonporous.

Another aspect provides an electrochemical cell including an electrode as described herein. In some embodiments, the electrochemical cell includes a first electrode; a second electrode; and an electrolyte disposed between the first electrode and the second electrode. At least one of the first electrode or the second electrode includes a first iron material, wherein the first iron material is a first reduced iron; and a second iron material that is different from the first iron material. For example, at least one of the first electrode or the second electrode may be prepared from a composition that includes a first iron material, wherein the first iron material is a first reduced iron; and a second iron material that is different from the first iron material. The first iron material and the second iron material are as described herein.

In some embodiments, at least one of the first electrode or the second electrode may further include an additive. For example, the additive may include copper, lead, bismuth, indium, tin, aluminum, an alloy thereof, or a combination thereof. In some embodiments, the additive may be present in an amount of 0.001 to 10 wt %, preferably 0.1 to 5 wt %, based on a total weight of the first electrode and/or the second electrode.

In some embodiments, the first electrode may include the first iron material and the second iron material as described herein, wherein a discharge capacity during a fifth to twentieth cycle of the electrochemical cell is substantially the same as a discharge capacity of a comparative electrochemical cell that includes a first electrode including the first iron material and without the second iron material. In other words, the electrode including the first iron material and the second iron material as described herein may achieve nearly the same discharge capacity during the fifth to twentieth cycles as a comparative electrode that includes the first iron material without the second iron material.

In some embodiments, the first electrode may include the first iron material and the second iron material as described herein, wherein a discharge capacity after a twenty-fifth cycle of the electrochemical cell may be greater than a discharge capacity of a comparative electrochemical cell that includes a first electrode including the first iron material and without the second iron material.

In some embodiments, the electrolyte may include a solid oxide electrolyte, a solid polymer electrolyte, a molten salt, an aqueous solution, a non-aqueous solution, a gel, or a combination thereof. For example, the electrolyte may include an aqueous solution of an alkali hydroxide, an organic hydroxide, or a combination thereof.

The electrolyte may be an aqueous solution. In some embodiments the electrolyte may be an alkaline solution (pH>10), a near-neutral solution (10>pH>4), or an acidic solution (4>pH>0). In some embodiments, the electrolyte may be an alkaline solution having a high hydroxide concentration, such as a hydroxide concentration at or above 5 moles per liter (M), e.g., 5 M to 6 M, 6 M or greater, 6 M to 7 M, 7 M or greater, 7 M to 11 M, 7 M to 10 M, 7.5 M to 9.5 M, or greater than 7.5 M to less than 9.5 M. In some embodiments, the solvent in the electrolyte may be water. In an aspect, purified water may be used, preferably water avoiding calcium, copper, fluoride, chloride, or silica, preferably water having a content of less that 10 parts per million (ppm), 1 ppm, 0.01 ppm or 0.001 ppm of calcium, copper, fluoride, chloride, or silica. Deionized water is mentioned.

In various embodiments, the electrolyte may comprise KOH, NaOH, LiOH, RbOH, CsOH, FrOH, Be(OH)₂, Ca(OH)₂, Mg(OH)₂, Sr(OH)₂, Ra(OH)₂, Ba(OH)₂, or a combination thereof. In some embodiments, KOH, NaOH, and/or LiOH may be combined in a ratio whereby [KOH]>[NaOH]>[LiOH]. For example, some embodiments may include 4 M KOH, 2 M NaOH, 0.05 M LiOH, or other combinations thereof. In various embodiments, KOH, NaOH, and LiOH are combined in ratios whereby [NaOH]>[KOH]>[LiOH]. Still other embodiments may include 4 M NaOH, 2 M KOH, 0.05 M LiOH, or other combinations thereof.

In some embodiments, the electrolyte includes an aqueous solution of an alkali hydroxide, an organic hydroxide, or a combination thereof. For example, the alkali hydroxide, the organic hydroxide, or the combination thereof may be present in the aqueous solution in an amount from 20 to 50 wt %, based on a total weight of the electrolyte.

The electrolyte may optionally contain an additive to promote or inhibit certain desired or undesirable reactions. Any suitable amount of the additive may be included in the electrolyte. For example, the electrolyte may further include a hydrogen evolution reaction suppressor (HER suppressor), an iron activator (e.g., a sulfide salt, such as bismuth sulfide (Bi₂S₃) or sodium sulfide (Na₂S)), or the like, or a combination thereof. In some embodiments, electrolyte may further include an alkali metal sulfide or a polysulfide including one or more of lithium sulfide (Li₂S) or polysulfide (Li₂Sₓ, x=2 to 6), sodium sulfide (Na₂S) or polysulfide (Na₂Sₓ, x=2 to 6), potassium sulfide (K₂S) or polysulfide (K₂Sₓ, x=2 to 6), cesium sulfide (Cs₂S) or polysulfide (Cs₂Sₓ, x=2 to 6), or the like, or a combination thereof. Non-limiting examples of additives include sodium sulfide (Na₂S), potassium sulfide (K₂S), lithium sulfide (Li₂S), iron sulfides (FeSₓ, where x=1 to 2), bismuth sulfide (Bi₂S₃), lead sulfide (PbS), zinc sulfide (ZnS), antimony sulfide (Sb₂S₃), selenium sulfide (SeS₂), tin sulfides (SnS, SnS₂, Sn₂S₃), nickel sulfide (NiS), molybdenum sulfide (MoS₂), mercury sulfide (HgS), bismuth oxide (Bi₂O₃), or the like, or a combination thereof. In addition, the electrolyte may include other components, including those as described herein and those known in the art.

In some embodiments, the HER suppressor additive may include one or more of sodium thiosulfate, sodium thiocyanate, polyethylene glycol (PEG) 1000, trimethylsulfoxonium iodide, zincate (by dissolving ZnO in NaOH), hexanethiol, decanethiol, sodium chloride, sodium permanganate, lead (IV) oxide, lead (II) oxide, magnesium oxide, sodium chlorate, sodium nitrate, sodium acetate, iron phosphate, phosphoric acid, sodium phosphate, ammonium sulfate, ammonium thiosulfate, lithopone, magnesium sulfate, iron(III) acetylacetonate, hydroquinone monomethyl ether, sodium metavanadate, sodium chromate, glutaric acid, dimethyl phthalate, methyl methacrylate, methylpentynol, adipic acid, allyl urea, citric acid, thiomalic acid, N-(2-aminoethyl)-3-aminopropyl trimethoxysilane, propylene glycol, trimethoxysilyl propyl diethylene, aminopropyl trimethoxysilane, dimethyl acetylenedicarboxylate (DMAD), 1,3-diethylthiourea, N,N′-diethylthiourea, aminomethyl propanol, methyl butynol, amino modified organosilane, succinic acid, isopropanolamine, phenoxyethanol, dipropylene glycol, benzoic acid, N-(2-aminoethyl)-3-aminopropyl, behenamide, 2-phosphonobutane tricarboxylic, mipa borate 3-methacryloxypropyltrimethoxysilane, 2-ethylhexoic acid, isobutyl alcohol, t-butylaminoethyl methacrylate, diisopropanolamine, propylene glycol n-propyl ether, sodium benzotriazolate, pentasodium aminotrimethylene phosphonate, sodium cocoyl sarcosinate, laurylpyridinium chloride, steartrimonium chloride, stearalkonium chloride, calcium montanate, quaternium-18 chloride, sodium hexametaphosphate, dicyclohexylamine nitrite, lead stearate, calcium dinonylnaphthalene sulfonate, iron(II) sulfide, sodium bisulfide, pyrite, sodium nitrite, complex alkyl phosphate ester (e.g. RHODAFAC® RA 600 Emulsifier), 4-mercaptobenzioc acid, ethylenediaminetetraacetic acid, ethylenediaminetetraacetate (EDTA), 1,3-propylenediaminetetraacetate (PDTA), nitrilotriacetate (NTA), ethylenediaminedisuccinate (EDDS), diethylenetriaminepentaacetate (DTPA), and other aminopolycarboxylates (APCs), diethylenetriaminepentaacetic acid, 2-methylbenzenethiol, 1-octanethiol, bismuth sulfide, bismuth oxide, antimony(III) sulfide, antimony(III) oxide, antimony(V) oxide, bismuth selenide, antimony selenide, selenium sulfide, selenium(IV) oxide, propargyl alcohol, 5-hexyn-1-ol, 1-hexyn-3-ol, N-allylthiourea, thiourea, 4-methylcatechol, trans-cinnamaldehyde, iron(III) sulfide, calcium nitrate, hydroxylamines, benzotriazole, furfurylamine, quinoline, tin(II) chloride, ascorbic acid, tetraethylammonium hydroxide, calcium carbonate, magnesium carbonate, antimony dialkylphosphorodithioate, potassium stannate, sodium stannate, tannic acid, gelatin, saponin, agar, 8-hydroxyquinoline, bismuth stannate, potassium gluconate, lithium molybdenum oxide, potassium molybdenum oxide, hydrotreated light petroleum oil, heavy naphthenic petroleum oil (e.g., sold as Rustlick® 631), antimony sulfate, antimony acetate, bismuth acetate, hydrogen-treated heavy naphtha (e.g., sold as WD-40), tetramethylammonium hydroxide, NaSb tartrate, urea, D-glucose, C₆Na₂O₆, antimony potassium tartrate, hydrazinesulphate, silica gel, triethylamine, potassium antimonate trihydrate, sodium hydroxide, 1,3-di-o-tolyl-2-thiourea, 1,2-diethyl-2-thiourea, 1,2-diisopropyl-2-thiourea, N-phenylthiourea, N,N′-diphenylthiourea, sodium antimony L-tartrate, rhodizonic acid disodium salt, sodium selenide, or the like, or a combination thereof.

In some embodiments, the electrochemical cell may further include a separator that is disposed between the first electrode and the second electrode. The separator may be a passive separator, such as conventional diaphragm separators, or may be an active separator, such as ion exchange membranes. In some embodiments, a separator may be chosen based on an ability to allow selective transfer of desired molecules or materials while substantially limiting or preventing transfer of undesired molecules or materials. For example, some separator membranes are ion-selective and allow the transfer of negative (or positive) ions while substantially preventing transfer of positive (or negative) ions. In other examples, separator materials may be chosen based on an ability to allow or prevent the cross-over of gas bubbles from one side (associated with one electrode) to the opposite side (associated with the counter-electrode).

In some embodiments, the separator may be formed of a dielectric material, or a porous material, which is permeable to positive ions, such as Fe²⁺, Fe³⁺, K⁺, Na⁺, Cs⁺, and/or NH₄⁺ ions, or the like, or a combination thereof, or negative ions, such as hydroxide ions, or the like. The separator may be impermeable or effectively impermeable to active materials of the catholyte and anolyte. In some embodiments, the separator may be a membrane, such as a membrane formed from a polymer with a tetrafluoroethylene backbone and side chains of perfluorovinyl ether groups terminated with sulfonate groups (e.g., a sulfonated tetrafluoroethylene membrane, a membrane made of polymers sold under the Nafion brand name, etc.), or the like.

In some embodiments, the separator may include an anion exchange membrane (AEM), a cation exchange membrane (CEM), a zwitterionic membrane, a porous membrane having an average pore diameter of less than 10 nanometers, a polybenzimidazole-containing membrane, a polysulfone-containing membrane, polycarboxylic-containing membrane, a polyetherketone-containing membrane, a membrane including polymer(s) of intrinsic microporosity (PIM), or the like, or a combination thereof. Preferably, the separator includes an anion exchange membrane (AEM) or a cation exchange membrane (CEM). In some embodiments, the separator may include a composite membrane including an inorganic material and an organic material. In some embodiments, the inorganic material may include a metal oxide or a ceramic material. In some embodiments, the organic material may include a polyether ether ketone (PEEK), a polysulfone, a polystyrene, a polypropylene, a polyethylene, or the like, or a combination thereof.

In some embodiments, a separator may be used that provides a physical barrier between the iron electrode and the OER electrode. For example, the separator may include a porous polyolefin film, a glass fiber mat, a cotton fabric, a rayon fabric, cellulose acetate, paper, or the like, or a combination thereof. In some embodiments, the separator may be a dielectric structure or frame, a ribbed structure, or a porous insulator. In some embodiments, the separator may include a porous frame configured to compress the iron electrode.

In the electrochemical cell, the second electrode may include carbon, titanium, lead, nickel, platinum, iridium, ruthenium, tantalum, niobium, zirconium, vanadium, hafnium, aluminum, cobalt, antimony, tungsten, an alloy thereof, an oxide thereof, or a combination thereof. The second electrode may be an oxygen evolution reaction (OER) electrode or an oxygen reduction reaction electrode (ORR). In some embodiments, the electrochemical cell may further include a third electrode, as shown in FIG. 1. For example, the electrochemical cell may include an iron electrode in contact with an anode current collector; an oxygen reduction reaction electrode having a first surface facing the iron electrode and an opposing second surface in contact with air; and an oxygen evolution reaction electrode, wherein the electrolyte is in contact with the iron electrode, the first surface of the oxygen reduction reaction electrode, and the oxygen evolution reaction electrode.

The OER electrode may be permeable to the electrolyte. For example, the OER electrode may be formed from a porous metal sheet or mesh. In some embodiments, the OER electrode may preferably be formed of a nickel mesh or a nickel-plated steel mesh. The OER electrode may include an oxygen evolution catalyst. For example, in some embodiments, the OER electrode may include a porous metal mesh and an oxygen evolution catalyst.

Exemplary oxygen evolution catalysts may include nickel, alloys of nickel with iron, manganese oxide, iron, nickel oxide (NiOₓ), nickel oxyhydroxide (NiOₓ(OH)_{y}), iron oxide, (FeOₓ), iron oxyhydroxide (FeOₓ(OH)_{y}), or the like. The OER electrode may be disposed closer to the iron electrode than the ORR electrode to facilitate charging. The OER may be electrically insulated from the iron electrode and the ORR electrode.

The ORR electrode is electrically conductive and permeable to oxygen. The ORR electrode may include a conductive gas diffusion electrode (GDE) catalyst, such as carbon, manganese oxide, silver, platinum, nickel foam, a nickel mesh, or the like, and may also include a hydrophobic material, such as polytetrafluoroethylene (PTFE), for example. For example, the ORR electrode may include a hydrophilic region and a hydrophobic region. The hydrophobic region may be exposed to air and the hydrophilic region may be exposed to the electrolyte. In other words, the hydrophilic region that is exposed to the electrolyte is the side that is facing the plurality of channels of the iron electrode.

A distance between electrodes, the interelectrode gap, may also be varied, to provide a suitable ohmic drop. In some embodiments, the interelectrode gap may be 1 millimeter (mm) to 100 mm. For example, the interelectrode gap may be 2 mm to 50 mm, or 3 mm to 30 mm, or 4 mm to 20 mm.

In some embodiments, the voltage of the electrochemical cell may be from 1.5 to 5.0 Volts (V), preferably from 1.6 to 2.9 V, and more preferably from 1.7 to 2.8 V. In still other embodiments, the voltage of the electrochemical cell may be from 2.6 to 5.0 V, or from 2.8 to 4.0 V. The mechanism for optimizing cell voltage within the electrochemical cell will vary in accordance with various exemplary aspects and embodiments described herein. Moreover, the overall cell voltage achievable is dependent upon a number of other interrelated factors, including reaction chemistry, electrode spacing, the configuration and materials of construction of the electrodes, the configuration and materials of construction of the separators, electrolyte concentrations, current density, electrolyte temperature, and, to a smaller extent, the nature and amount of any additives to the electrochemical process (such as, for example, flocculants, surfactants, or the like).

Also provided is a method of preparing the electrode that is described herein. The electrode may be prepared by providing a blend of a first iron material and a second iron material, wherein the first iron material is a first reduced iron, and the second iron material that is different from the first iron material; and forming the blend into the electrode. The forming may be performed using any suitable conditions, including low temperature processing.

In some embodiments, the forming may include applying pressure and/or heat to the blend for a time to form the electrode. For example, the pressure and/or heat may be applied by hot isostatic pressing, uniaxial hot pressing, hot roll compaction, hot briquetting, hot forging, or a combination thereof, but embodiments are not limited thereto. In some embodiments, the applied heat may be at a temperature of 300 to 1000° C., preferably 700 to 950° C.; the applied pressure may be 0.1 to 200 MPa; the time may be 1 second to 24 hours; or a combination thereof.

In some embodiments, the consolidation process, such as roll compaction, isostatic pressing, and uniaxial pressing, may be conducted at room temperature, or at a temperature substantially lower than what is typically used in industry for a given compaction process. In some embodiments the composition, microstructure, and/or shape of the iron materials may be formulated to facilitate billet formation at lower temperatures. In some embodiments, a physical, chemical, or other surface treatment may be used to facilitate billet formation at lower temperatures. Low temperature processing may be at a temperature of 10 to 100° C., 10 to 30° C., 20 to 50° C., or the like.

Also provided is a method of forming an active material for an electrode that includes providing an iron material and an additive, and forming the iron material and the additive into the active material, wherein the forming includes atomizing the iron material and the additive.

In some embodiments, the atomizing may include gas atomization, water atomization, granulation, or a combination thereof. For example, the atomizing may include gas atomization.

In some embodiments, the additive may be present in an amount of 0.001 to 10 wt %, preferably 0.01 to 5 wt %, based on a total weight of the active material.

The additive may include lead, bismuth, indium, tin, aluminum, an alloy thereof, or a combination thereof.

The iron material may be iron ore, scrap iron, mill scale, pickle-liquor recovered iron, or a combination thereof.

In some embodiments, the active material may have a D50 particle size of 5 to 500 μm, preferably 20 to 400 μm. In some embodiments, the active material may have an apparent density of 0.5 to 4 grams per cubic centimeter (g/cm³), 0.5 to 3.8 g/cm³, 0.5 to 3.2 g/cm³, 0.5 to 1.8 g/cm³, 0.6 to 2.4 g/cm³, 1.2 to 2.0 g/cm³, or 1.8 to 3.2 g/cm³.

In some embodiments, the active material may further include a second iron material, wherein the second iron material is a second reduced iron. In some embodiments, the second iron material may be a second sponge iron or a second direct reduced iron. For example, the second iron material may be a second direct reduced iron. In other embodiments, the second iron material may be a second atomized iron, such as water atomized iron, gas atomized iron, or granulated iron.

In some embodiments, the active material may include 5 to 95 wt % of the iron material, and 5 to 95 wt % of the second iron material, each based on a total weight of iron in the active material. In some embodiments, the active material may include 10 to 75 wt % of the iron material, and 25 to 90 wt % of the second iron material, each based on a total weight of iron in the active material. In still other embodiments, the active material may include 10 to 50 wt % of the iron material, 50 to 90 wt % of the iron material, or 25 to 75 w % of the iron material, based on a total weight of iron in the active material. The active material may include 10 to 50 wt % of the second iron material, 50 to 90 wt % of the second iron material, or 25 to 75 w % of the second iron material, based on a total weight of iron in the active material.

In some embodiments, the second iron that is added to the active material may include a second atomized iron, wherein the second iron material has a D50 particle size of 5 to 250 μm, preferably 20 to 150 μm, more preferably 25 to 70 μm; an apparent density of 0.5 to 3.8 g/cm³, or 1.8 to 3.2 g/cm³; or a combination thereof.

Also provided is an electrochemical cell that includes a first electrode; a second electrode; and an electrolyte disposed between the first electrode and the second electrode, wherein at least one of the first electrode or the second electrode includes the active material prepared by the method provided herein.

Still another aspect provides a method of forming an electrode including providing an initial iron material having a first apparent density and a first surface area; oxidizing the initial iron material to form an oxidized iron material; reducing the oxidized iron material to form an iron material, wherein the iron material has a second apparent density and a second surface area, wherein the second apparent density is less than the first apparent density, and the second surface area is greater than the first surface area, and forming the iron material into the electrode.

In some embodiments, the first apparent density may be 0.5 to 4.0 g/cm³, and the first surface area is 1 to 400 square meters per kilogram (m²/kg), 1 to 10 m²/kg, 1 to 90 m²/kg, or 1 to 190 m²/kg.

In some embodiments, the second apparent density is 0.5 to 4.0 g/cm³, preferably 1.2 to 2.0 g/cm³, 1.8 to 3.2 g/cm³, or 0.5 to 1.8 g/cm³, and the second surface area is 200 to 5000 m²/kg, 500 to 5000 m²/kg, 20 to 800 m²/kg, preferably 100 to 800 m²/kg.

In some embodiments, the oxidizing may include contacting with an aqueous salt solution, heating, steam treating, or a combination thereof.

In some embodiments, the contacting with an aqueous salt solution may be for 1 to 96 hours, 12 to 96 hours, 24 to 96 hours, or 36 to 96 hours.

In some embodiments, the aqueous salt solution may include sodium chloride, potassium chloride, lithium chloride, or a combination thereof. The aqueous salt solution may contain sodium chloride, potassium chloride, lithium chloride, or a combination thereof at a concentration of 0.1 to 25 wt %, 0.5 to 15 wt %, or 0.1 to 10 wt %.

In some embodiments, the reducing may include heating in the presence of a reducing agent, preferably wherein the reducing agent includes hydrogen or carbon monoxide, more preferably hydrogen. The reducing can be for any suitable period of time. In some embodiments, the reducing may be for 30 minutes to 6 hours, preferably 1 to 4 hours.

The reducing may be performed at any suitable temperature. In some embodiments, the reducing may be at a temperature of 400 to 1200° C., preferably 550 to 1100° C., more preferably 800 to 1100° C.

In some embodiments, the forming may include atomizing the iron material. For example, the atomizing may include gas atomization, water atomization, granulation, or a combination thereof.

In some embodiments, the method may further include combining the iron material and an additive before the step of forming the electrode. Any suitable additive may be included. For example, the additive may include lead, bismuth, indium, tin, aluminum, an alloy thereof, or a combination thereof.

In some embodiments, the initial iron material may include a sponge iron, a direct reduced iron, an atomized iron, an electrolytic iron, a carbonyl iron, an iron oxide, or a combination thereof.

In some embodiments, the initial iron material may have a D50 particle size of 10 to 500 micrometers.

In some embodiments, the iron material may have a D50 particle size of 10 to 500 micrometers.

In some embodiments, the method may further include combining the iron material with a second iron material before the step of forming the electrode, wherein the second iron material is different from the iron material.

In some embodiments, the second iron material may include an atomized iron, an electrolytic iron, a carbonyl iron, an iron oxide, a second reduced iron, or a combination thereof.

In some embodiments, the electrode may include 5 to 95 wt % of the iron material, and 5 to 95 wt % of the second iron material, each based on a total weight of the electrode. In some embodiments, the electrode may include 10 to 75 wt % of the iron material, and 25 to 90 wt % of the second iron material, each based on a total weight of the electrode. In still other embodiments, the electrode may include 10 to 50 wt % of the iron material, and 50 to 90 wt % of the second iron material, each based on a total weight of the electrode.

In some embodiments, the second iron material has a D50 particle size of 5 to 500 μm, or 20 to 400 μm.

In some embodiments, the second iron material has an apparent density of 0.5 to 4.0 grams per cubic centimeter.

This disclosure is further described by the following examples, which are non-limiting.

### EXAMPLES

### Example 1

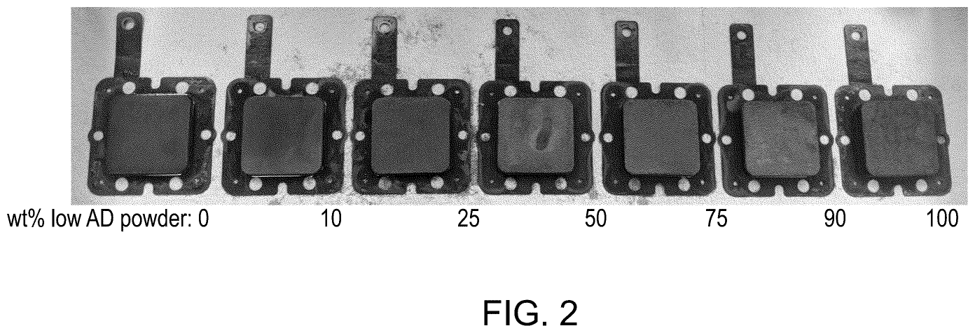

An electrode was prepared by combining different ratios of high-density sponge iron powder (apparent density 2.4 g/cm³) and a low-density sponge iron powder (apparent density 1.5 g/cm³) together. The sponge iron powders had D50s of 80 μm and 230 μm, respectively. Sponge iron powder with a particle size of less than 75 μm was removed prior to electrode fabrication. The iron powders were combined and then processed into an electrode by hot compaction. The electrode was assembled into an electrochemical cell with a KOH based electrolyte with a total hydroxide concentration of 6.5 M. Electrodes were cycled at temperatures of both 30° C. and 45° C. The electrodes were electrochemically cycled with an areal discharge rate of 7 mA/cm² and charge rate of 12 mA/cm². The nominal active area and thickness of the electrode were 26.2 cm² and 12 mm, respectively. As shown in FIG. 2, the incorporation of 10 wt % to 90 wt % of the low-density sponge iron powder provided electrodes without visible degradation after being operated in an electrochemical cell for 9 months.

### Example 2

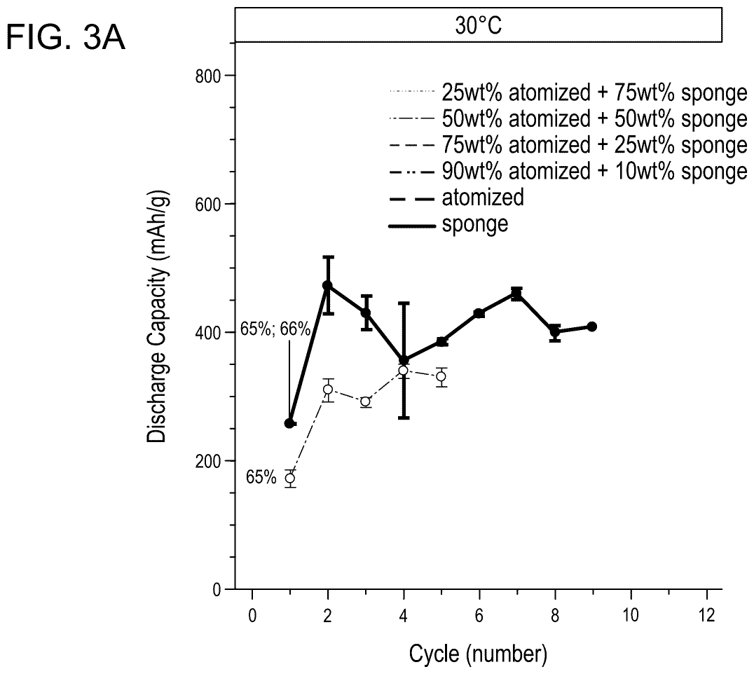

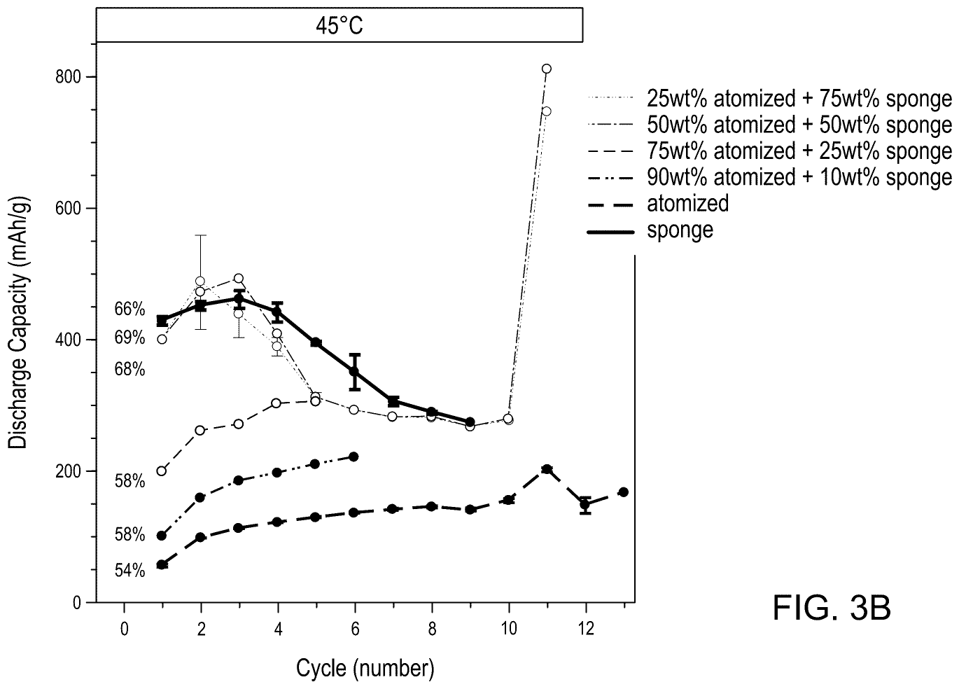

Electrodes were prepared by combining different ratios of sponge iron powder and atomized iron powder together. The sponge iron powder had a D50 of 230 μm and the atomized powder had a D50 of 245 μm. Sponge iron powder with a particle size of less than 75 μm was removed prior to electrode fabrication. The sponge iron powder had an apparent density of 1.5 g/cm³ and the atomized iron powder had an apparent density of 2.4 g/cm³. The atomized iron powder was water atomized. The iron powders were combined and then processed into an electrode by hot compaction. The electrode was assembled into an electrochemical cell with a KOH based electrolyte with a total hydroxide concentration of 6.5 M. Electrodes were cycled at temperatures of both 30° C. and 45° C. The electrodes were electrochemically cycled with an areal discharge rate of 12 mA/cm² and charge rate of 18 mA/cm². The nominal active area and thickness of the electrode were 26.2 cm² and 15 mm, respectively. As shown in FIGS. 3A and 3B, the incorporation of 25 wt % of atomized iron powder or 50 wt % atomized iron powder in combination with sponge iron powder provided similar performance to comparative electrodes prepared from 100 wt % of sponge iron powder for the first ten cycles when incorporated into an electrochemical cell.

### Example 3

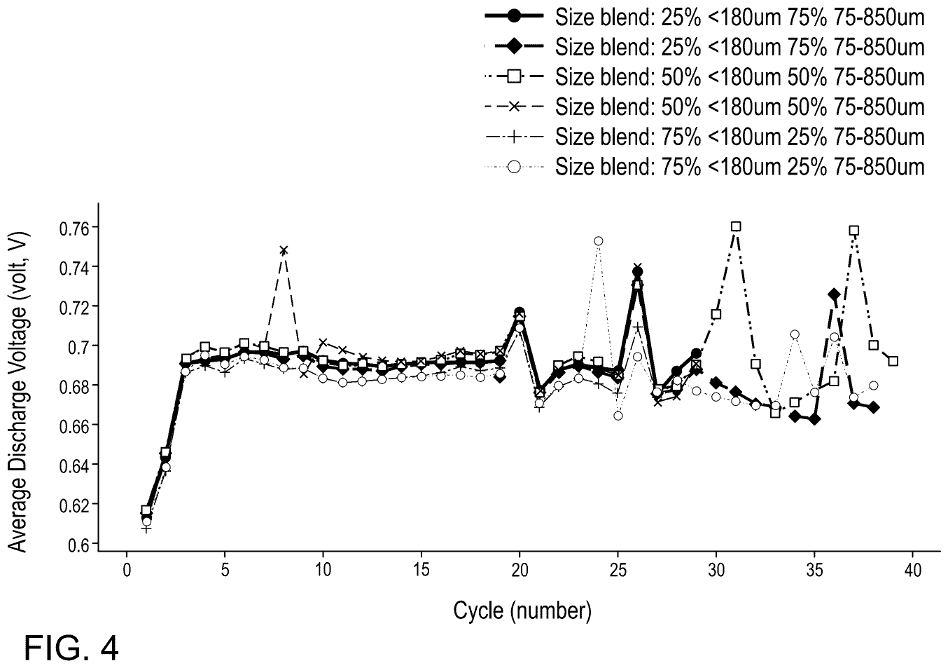

Electrodes were prepared by combining different ratios of sponge iron powders of different sieve cuts. Electrodes were prepared using 25 to 75 wt % material below 180 μm blended with a sponge iron with a D50 of 232 μm and sieved to 75 to 850 μm. Electrodes were prepared by hot compaction and tested in an electrochemical cell with KOH based electrolyte with a hydroxide concentration of 6.5 M. Electrodes were cycled at a temperature of 30° C. The electrodes were electrochemically cycled with an areal discharge rate of 15 mA/cm² and charge rate of 15 mA/cm². The nominal active area and thickness of the electrodes were 26.2 cm² and 3 mm, respectively. As shown in FIG. 4, blending finer particle size powders with coarser particles having lower apparent densities did not result in a decrease to voltage performance.

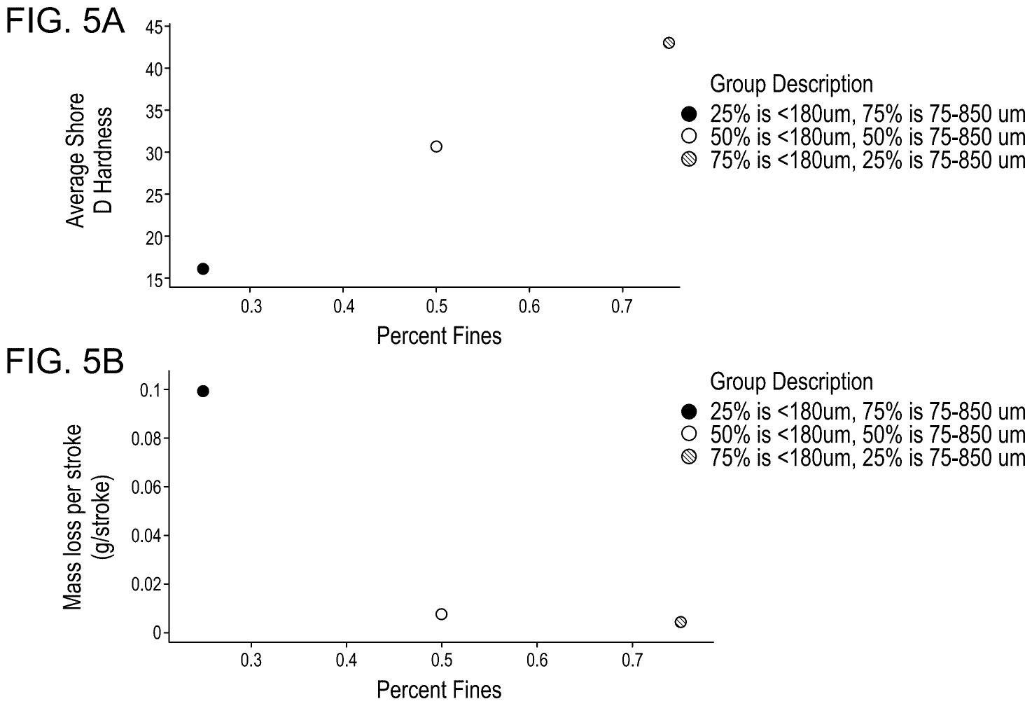

The Shore D hardness and the mass loss per stroke for the electrodes were measured. FIG. 5A shows the average Shore D hardness of the resulting blends including the different ratios of particle sizes. FIG. 5B shows the mass loss per stroke (g/stroke) when the resulting blends having the different ratios of particle sizes were used. As shown in FIGS. 5A and 5B, blending finer particle size powders with coarser particles having lower apparent densities increased the mechanical durability and cell lifetime.

### Example 4

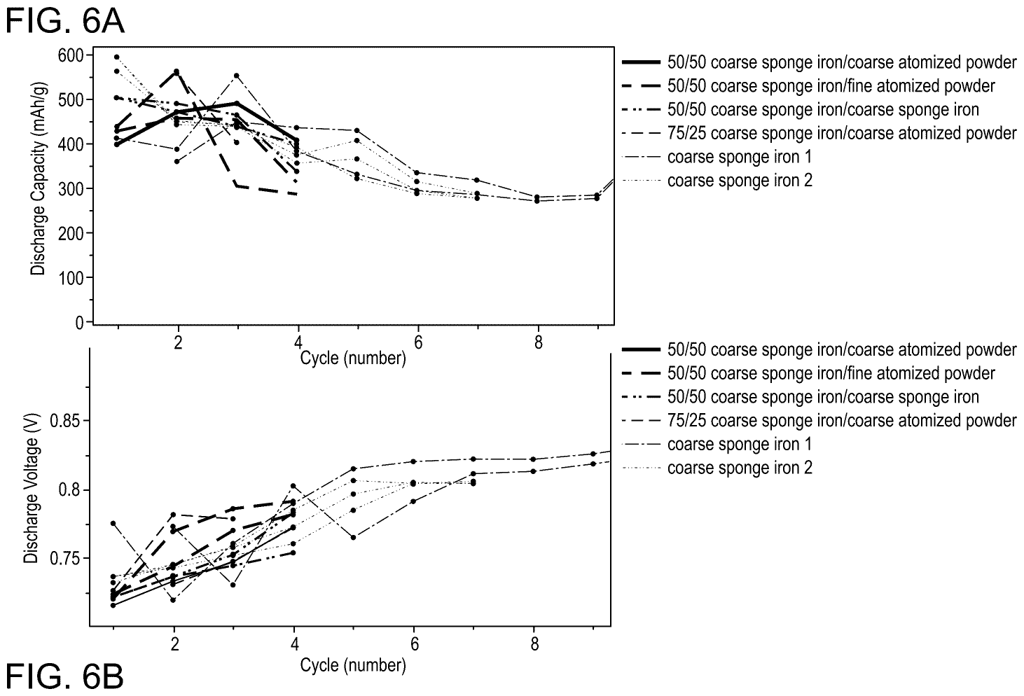

Electrodes of varying weight percentages of a coarse sponge iron, coarse atomized iron power and a fine atomized iron powder were blended together and electrodes were prepared by hot compaction. The coarse sponge iron had a D50 of 232 μm, the coarse atomized iron powder had a D50 of 245 μm, and the fine atomized iron powder had a D50 of 58 μm. These electrodes were then assembled into electrochemical cells and 10 cycles performed. As shown in FIG. 6A, electrodes prepared using blends of coarse sponge iron and coarse atomized iron powder, coarse sponge iron and fine atomized iron powder, coarse sponge iron and coarse sponge iron, and coarse sponge iron and coarse atomized powder each provided comparable discharge capacity performance to electrodes prepared from either of the coarse sponge iron powders alone. The electrodes were assembled into an electrochemical cell with a KOH based electrolyte with a total hydroxide concentration of 6.5M. Electrodes of this embodiment were cycled at a temperature of 45° C. The electrodes were electrochemically cycled with an areal discharge rate of 12 mA/cm² and charge rate of 18 mA/cm². The nominal active area and thickness of the electrode were 26.2 cm² and 15 mm, respectively. As shown in FIG. 6B, electrodes prepared using blends of coarse sponge iron and coarse atomized iron powder, coarse sponge iron and fine atomized iron powder, coarse sponge iron and coarse sponge iron, and coarse sponge iron and coarse atomized powder each provided comparable discharge voltage performance to electrodes prepared from either of the coarse sponge iron powders alone.

### Example 5

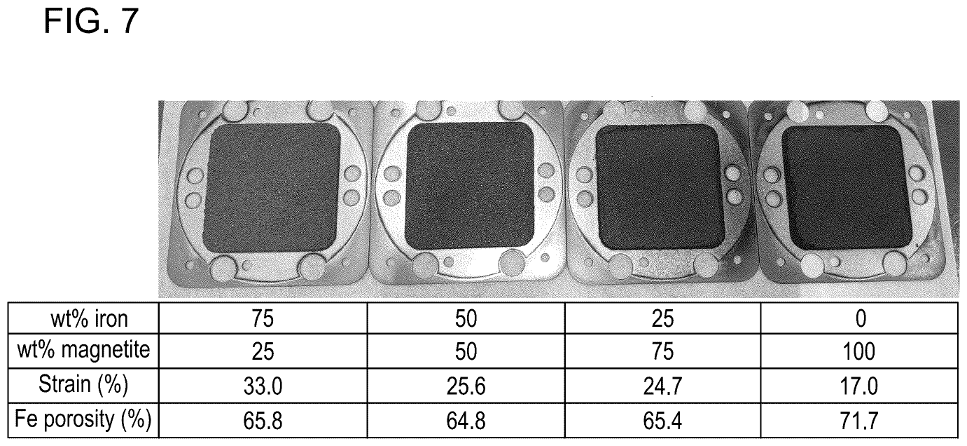

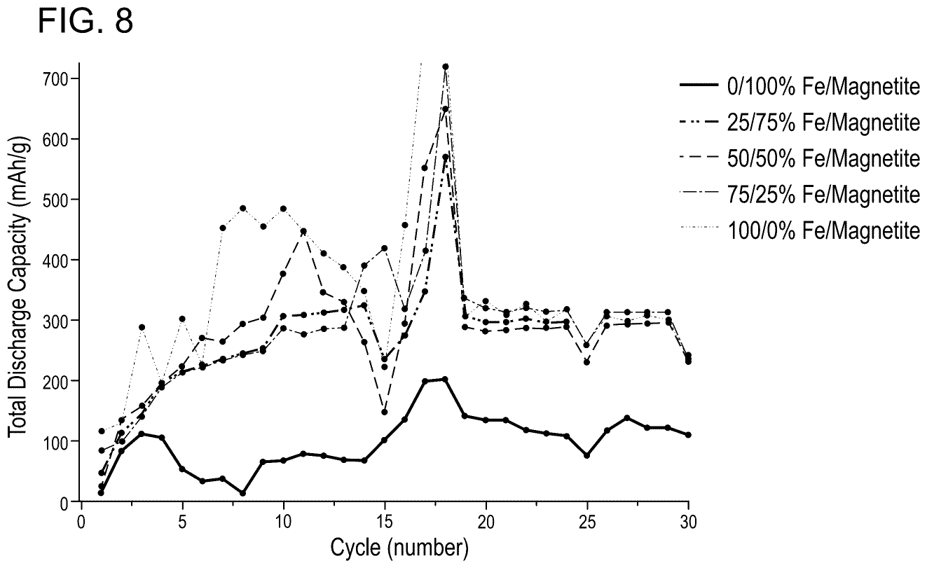

Electrodes were prepared by combining different ratios of sponge iron powder and iron oxide powder (magnetite) together. The iron powders were combined and then processed into an electrode by hot compaction. The electrodes were assembled into an electrochemical cell with a KOH based electrolyte with a total hydroxide concentration of 6.5 M. Electrodes were cycled at temperatures of 30° C. and 45° C. The electrodes were electrochemically cycled with an areal discharge rate of 7.5 mA/cm² and charge rate of 30 mA/cm². The nominal active area and thickness of the electrode were 26.67 cm² and between 2 and 4 mm, respectively. The material ratios, strain, and porosity are provided in FIG. 7. The incorporation of 25 wt % to 75 wt % of the iron oxide powder allowed for the formation of an electrode that had no substantial decrease in discharge capacity access after electrochemical conditioning. As shown in FIG. 8, a similar discharge capacity was achieved between 20 to 30 cycles by the incorporation of 25 wt % to 75 wt % of the iron oxide powder into the electrodes as compared to comparative electrodes using 100 wt % of the sponge iron powder.

### Example 6

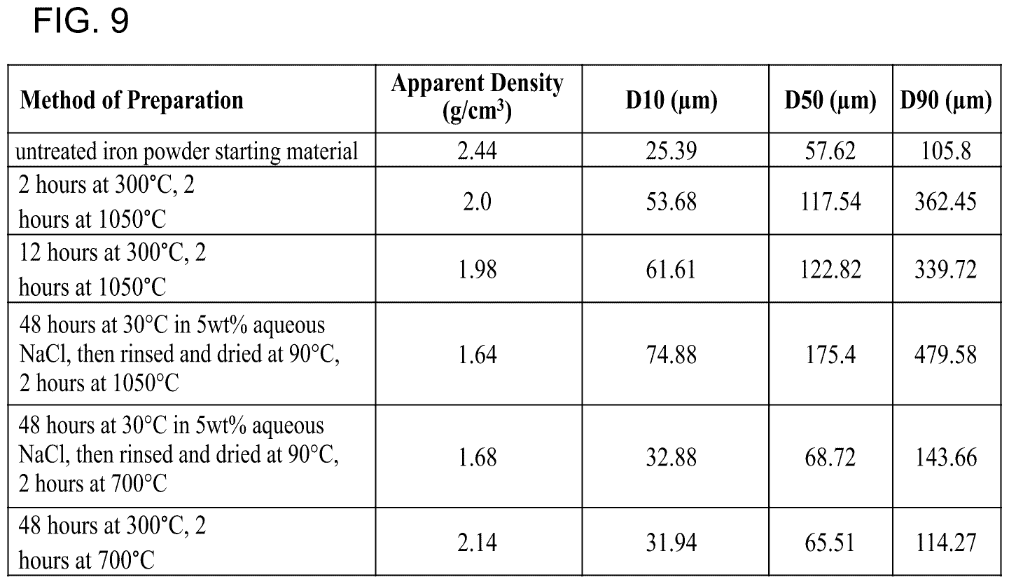

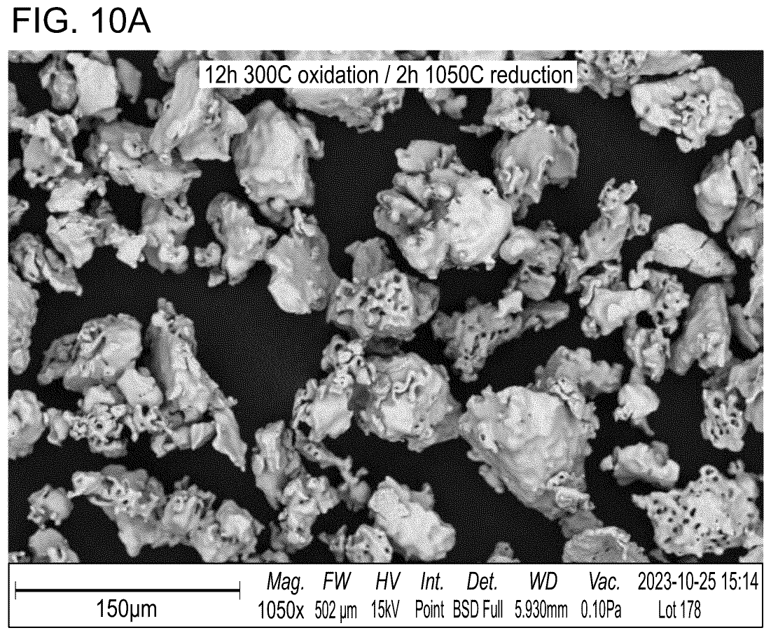

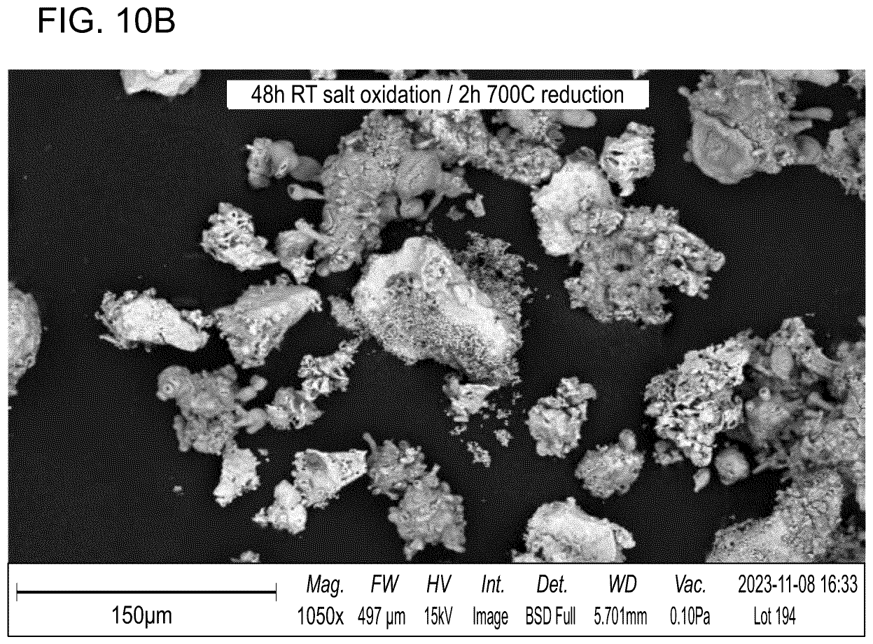

A high density, low surface area iron powder was oxidized and reduced to lower the apparent density and to increase the surface area of the iron powder. FIG. 9 shows a table of the apparent density, D10 particle size, D50 particle size, and D90 particle size of the starting material and the resulting iron powder provided by the indicated methods. FIG. 10A is a scanning electron micrograph of the iron powder product prepared by oxidation at 12 hours at 300° C. and reduction at 1050° C. for 2 hours. FIG. 10B is a scanning electron micrograph of the iron powder product prepared by room temperature oxidation in a brine solution for 40 hours and reduction at 700° C. for 2 hours.

This disclosure further encompasses the following aspects.

Aspect 1. An electrode, including a first iron material, wherein the first iron material is a first reduced iron; and a second iron material that is different from the first iron material.

Aspect 2. The electrode of aspect 1, wherein the first reduced iron is a first atomized iron, a first sponge iron, or a first direct reduced iron.

Aspect 3. The electrode of aspect 1 or 2, wherein the second iron material comprises an electrolytic iron, a carbonyl iron, an iron oxide, a second reduced iron, or a combination thereof, wherein the second reduced iron comprises a second atomized iron, a second direct reduced iron, a second sponge iron, or a combination thereof.

Aspect 4. The electrode of any of aspects 1 to 3, including 5 to 95 weight percent of the first iron material, and 5 to 95 weight percent of the second iron material, each based on a total weight of the electrode; preferably comprising 10 to 75 weight percent of the first iron material, and 25 to 90 weight percent of the second iron material, each based on a total weight of the electrode; and more preferably comprising 10 to 50 weight percent of the first iron material, and 50 to 90 weight percent of the second iron material, each based on a total weight of the electrode.

Aspect 5. The electrode of any of aspects 1 to 4, wherein the first iron material has a D50 particle size of less than 45 micrometers, 40 to 700 micrometers, preferably 120 to 450 micrometers.

Aspect 6. The electrode of any of aspects 1 to 5, wherein the first iron material comprises a first sponge iron or a first direct reduced iron, and has an apparent density of 0.5 to 3.5 grams per cubic centimeter, preferably 0.8 to 2.0 grams per cubic centimeter.

Aspect 7. The electrode of any of aspects 1 to 6, wherein the first iron material comprises a first atomized iron and has an apparent density of 0.5 to 4 grams per cubic centimeter, 1.5 to 3.8 grams per cubic centimeter, or preferably 1.8 to 3.2 grams per cubic centimeter.

Aspect 8. The electrode of any of aspects 1 to 7, wherein the second iron material has a D50 particle size of 5 to 500 micrometers, preferably 20 to 400 micrometers.

Aspect 9. The electrode of any of aspects 1 to 8, wherein the first iron material has a D50 particle size of less than 45 micrometers, 10 to 45 micrometers, 20 to 45 micrometers, or 25 to 45 micrometers, and the second iron material has a D50 particle size of 5 to 500 micrometers, 50 to 500 micrometers, or preferably 20 to 400 micrometers.

Aspect 10. The electrode of any of aspects 1 to 9, wherein the second iron material has an apparent density of 0.5 to 4 grams per cubic centimeter.

Aspect 11. The electrode of any of aspects 1 to 10, wherein the second iron material is a second atomized iron.

Aspect 12. The electrode of any of aspects 1 to 11, wherein the first atomized iron is water atomized iron, gas atomized iron, or granulated iron, wherein the second atomized iron is water atomized iron, gas atomized iron, or granulated iron.

Aspect 13. The electrode of any of aspects 1 to 12, wherein the second iron material comprises an iron oxide.

Aspect 14. The electrode of aspect 11, wherein the iron oxide comprises hematite, magnetite, maghemite, wustite, martite, goethite, limonite, siderite, pyrite, ilmenite, spinel manganese ferrite, or a combination thereof.

Aspect 15. The electrode of any of aspects 1 to 14, wherein the second iron material comprises a second atomized iron, wherein the second iron material has a D50 particle size of 10 to 250 micrometers, preferably 20 to 150 micrometers, more preferably 25 to 70 micrometers; an apparent density of 0.5 to 3.8 grams per cubic centimeter, preferably 1.8 to 3.2 grams per cubic centimeter; or a combination thereof.

Aspect 16. The electrode of any of aspects 1 to 15, wherein the second iron material comprises a second reduced iron, wherein the second iron material has a D50 particle size of 5 to 500 micrometers, preferably 150 to 300 micrometers; an apparent density of 0.5 to 3.2 grams per cubic centimeter, preferably 0.5 to 1.8 grams per cubic centimeter; or a combination thereof.

Aspect 17. The electrode of any of aspects 1 to 16, wherein the second iron material comprises an iron oxide, wherein the iron oxide has a D50 particle size of 10 to 500 micrometers, preferably 35 to 210 micrometers, more preferably 35 to 150 micrometers.

Aspect 18. The electrode of any of aspects 1 to 17, further comprising an additive.

Aspect 19. The electrode of aspect 18, wherein the additive comprises copper, lead, bismuth, indium, tin, aluminum, an alloy thereof, or a combination thereof.

Aspect 20. The electrode of aspect 18 or 19, wherein the additive is present in an amount of 0.001 to 10 weight percent, preferably 0.1 to 5 weight percent, based on a total weight of the electrode.

Aspect 21. The electrode of any of aspects 1 to 20, wherein the first reduced iron is a first atomized iron and the second iron material is an iron oxide; the first reduced iron is a first atomized iron and the second iron material is a second atomized iron; the first reduced iron is a first sponge iron and the second iron material is a second atomized iron; or the first reduced iron is a first sponge iron and the second iron material is an iron oxide.

Aspect 22. The electrode of any of aspects 1 to 21, further comprising a third iron material, wherein the third iron material is different from the first iron material and the second iron material.

Aspect 23. The electrode of aspect 22, wherein the third iron material comprises an electrolytic iron, a carbonyl iron, a second iron oxide, a third reduced iron, or a combination thereof, wherein the third reduced iron comprises a third atomized iron, a third direct reduced iron, or a combination thereof.

Aspect 24. The electrode of aspect 22 or 23, including 5 to 90 weight percent of the first iron material, 5 to 90 weight percent of the second iron material, and 5 to 90 weight percent of the third iron material, each based on a total weight of the electrode; preferably comprising 10 to 70 weight percent of the first iron material, 15 to 80 weight percent of the second iron material, and 15 to 80 weight percent of the third iron material, each based on a total weight of the electrode; and more preferably comprising 10 to 50 weight percent of the first iron material, 25 to 75 weight percent of the second iron material, and 25 to 75 weight percent of the third iron material, each based on a total weight of the electrode.

Aspect 25. The electrode of any of aspects 22 to 24, wherein the third iron material has a D50 particle size of 5 to 850 micrometers.

Aspect 26. The electrode of any of aspects 22 to 25, wherein the third iron material has an apparent density of 0.5 to 4 grams per cubic centimeter.

Aspect 27. The electrode of any of aspects 22 to 26, wherein the third iron material is a third atomized iron.

Aspect 28. The electrode of any of aspects 23 to 26, wherein the third atomized iron is water atomized iron, gas atomized iron, or granulated iron.

Aspect 29. The electrode of any of aspects 22 to 26, wherein the third iron material comprises a second iron oxide.

Aspect 30. The electrode of aspect 29, wherein the second iron oxide comprises hematite, magnetite, maghemite, wustite, martite, goethite, limonite, siderite, pyrite, ilmenite, spinel manganese ferrite, or a combination thereof.

Aspect 31. The electrode of any of aspects 1 to 30, further comprising an additive.

Aspect 32. The electrode of aspect 31, wherein the additive comprises copper, lead, bismuth, indium, tin, aluminum, an alloy thereof, or a combination thereof.

Aspect 33. The electrode of aspect 31 or 32, wherein the additive is present in an amount of 0.001 to 10 weight percent, preferably 0.1 to 5 weight percent, based on a total weight of the electrode.

Aspect 34. The electrode of any of aspects 22 to 33, wherein the electrode comprises: a sponge iron, an atomized iron, and an iron oxide; a sponge iron, an iron oxide, and an additive; a first sponge iron, a second sponge iron, and a third atomized iron, wherein the first sponge iron is different from the second sponge iron; a first sponge iron, a second sponge iron, and a second iron oxide, wherein the first sponge iron is different from the second sponge iron; a first sponge iron, a second atomized iron, and a third atomized iron, wherein the second atomized iron is different from the third atomized iron; or a first sponge iron, a first iron oxide, and a second iron oxide, wherein the first iron oxide is different from the second iron oxide.

Aspect 35. An electrochemical cell, including a first electrode; a second electrode; and an electrolyte disposed between the first electrode and the second electrode, wherein at least one of the first electrode or the second electrode comprises: a first iron material, wherein the first iron material is a first reduced iron; and a second iron material that is different from the first iron material, optionally wherein the first electrode is prepared from a composition comprising the first iron material, the second electrode is prepared from a composition comprising the second iron material, or both.

Aspect 36. The electrochemical cell of aspect 35, wherein the first reduced iron is a first atomized iron, a first sponge iron, or a first direct reduced iron.

Aspect 37. The electrochemical cell of aspect 35 or 36, wherein the second iron material comprises an electrolytic iron, a carbonyl iron, an iron oxide, a second reduced iron, or a combination thereof, wherein the second reduced iron comprises a second atomized iron, a second direct reduced iron, a second sponge iron, or a combination thereof.

Aspect 38. The electrochemical cell of any of aspects 35 to 37, wherein the at least one of the first electrode or the second electrode comprises: 5 to 95 weight percent of the first iron material, and 5 to 95 weight percent of the second iron material, each based on a total weight of the electrode; preferably comprising 10 to 75 weight percent of the first iron material, and 25 to 90 weight percent of the second iron material, each based on a total weight of the electrode; and more preferably comprising 10 to 50 weight percent of the first iron material, and 50 to 90 weight percent of the second iron material, each based on a total weight of the electrode.

Aspect 39. The electrochemical cell of any of aspects 35 to 38, wherein the first iron material has a D50 particle size of less than 45 micrometers, 40 to 700 micrometers, preferably 120 to 450 micrometers.

Aspect 40. The electrochemical cell of any of aspects 35 to 39, wherein the first iron material has an apparent density of 0.5 to 3.5 grams per cubic centimeter, preferably 0.8 to 2.0 grams per cubic centimeter.

Aspect 41. The electrochemical cell of any of aspects 35 to 40, wherein the second iron material has a D50 particle size of 5 to 500 micrometers, preferably 20 to 400 micrometers.

Aspect 42. The electrochemical cell of any of aspects 35 to 41, wherein the second iron material has an apparent density of 0.5 to 4 grams per cubic centimeter.

Aspect 43. The electrochemical cell of any of aspects 35 to 42, wherein the second iron material is a second atomized iron.

Aspect 44. The electrochemical cell of aspect 43, wherein the first atomized iron is water atomized iron, gas atomized iron, or granulated iron, wherein the second atomized iron is water atomized iron, gas atomized iron, or granulated iron.

Aspect 45. The electrochemical cell of any of aspects 35 to 42 or 44, wherein the second iron material comprises an iron oxide.

Aspect 46. The electrochemical cell of aspect 45, wherein the iron oxide comprises hematite, magnetite, maghemite, wustite, martite, goethite, limonite, siderite, pyrite, ilmenite, spinel manganese ferrite, or a combination thereof.

Aspect 47. The electrochemical cell of any of aspects 35 to 44, wherein the second iron material comprises a second atomized iron, wherein the second iron material has a D50 particle size of 10 to 250 micrometers, preferably 20 to 150 micrometers, more preferably 25 to 70 micrometers; an apparent density of 1.5 to 3.8 grams per cubic centimeter, preferably 1.8 to 3.2 grams per cubic centimeter; or a combination thereof.

Aspect 48. The electrochemical cell of any of aspects 35 to 42, wherein the second iron material comprises a second reduced iron, wherein the second iron material has a D50 particle size of 5 to 500 micrometers, preferably 150 to 300 micrometers; an apparent density of 0.5 to 3.2 grams per cubic centimeter, preferably 0.5 to 1.8 grams per cubic centimeter; or a combination thereof.

Aspect 49. The electrochemical cell of any of aspects 35 to 42 or 46, wherein the second iron material comprises an iron oxide, wherein the iron oxide has a particle size of 10 to 500 micrometers, preferably 35 to 210 micrometers, more preferably 35 to 150 micrometers.

Aspect 50. The electrochemical cell of any of aspects 35 to 49, wherein at least one of the first electrode or the second electrode further comprises an additive.

Aspect 51. The electrochemical cell of aspect 50, wherein the additive comprises copper, lead, bismuth, indium, tin, aluminum, an alloy thereof, or a combination thereof.

Aspect 52. The electrochemical cell of aspect 50 or 51, wherein the additive is present in an amount of 0.001 to 10 weight percent, preferably 0.1 to 5 weight percent, based on a total weight of the electrode.

Aspect 53. The electrochemical cell of any of aspects 35 to 52, wherein the first electrode comprises the first iron material and the second iron material, a discharge capacity during a fifth to twentieth cycle of the electrochemical cell is substantially the same as a discharge capacity of a comparative electrochemical cell that comprises a first electrode comprising the first iron material and without the second iron material.

Aspect 54. The electrochemical cell of any of aspects 35 to 52, wherein the first electrode comprises the first iron material and the second iron material, a discharge capacity after a twenty-fifth cycle of the electrochemical cell is greater than a discharge capacity of a comparative electrochemical cell that comprises a first electrode comprising the first iron material and without the second iron material.

Aspect 55. The electrochemical cell of any of aspects 35 to 54, wherein the electrolyte comprises an aqueous solution of an alkali hydroxide, an organic hydroxide, or a combination thereof.

Aspect 56. The electrochemical cell of aspect 55, wherein the alkali hydroxide, the organic hydroxide, or the combination thereof is present in the aqueous solution in an amount from 20 to 50 weight percent, based on a total weight of the electrolyte.

Aspect 57. The electrochemical cell of any of aspects 35 to 56, wherein the second electrode comprises carbon, titanium, lead, nickel, platinum, iridium, ruthenium, tantalum, niobium, zirconium, vanadium, hafnium, aluminum, cobalt, antimony, tungsten, an alloy thereof, an oxide thereof, or a combination thereof.

Aspect 58. The electrochemical cell of any of aspects 35 to 57, further comprising a third electrode.

Aspect 59. The electrochemical cell of aspect 58, including an iron electrode in contact with an anode current collector; an oxygen reduction reaction electrode having a first surface facing the iron electrode and an opposing second surface in contact with air; and an oxygen evolution reaction electrode, wherein the electrolyte is in contact with the iron electrode, the first surface of the oxygen reduction reaction electrode, and the oxygen evolution reaction electrode.

Aspect 60. The electrochemical cell of aspect 59, further comprising a separator disposed between at least a portion of the iron electrode and the oxygen evolution reaction electrode.

Aspect 61. A method of preparing an electrode, the method including providing a first blend of a first iron material and a second iron material, wherein the first iron material is a first reduced iron, and the second iron material that is different from the first iron material; and forming the first blend to provide the electrode comprising a second blend, wherein a surface area of the first blend is less than a surface area of the second blend.

Aspect 62. The method of aspect 61, wherein the forming of the first blend is performed in a reducing atmosphere.

Aspect 63. The method of aspect 61 or 62, wherein the forming comprises applying pressure and/or heat to the first blend for a time to form the electrode.

Aspect 64. The method of aspect 63, wherein the pressure and/or heat are applied by isostatic pressing, uniaxial pressing, roll compaction, briquetting, forging, or a combination thereof.

Aspect 65. The method of aspect 63 or 64, wherein the applying heat comprises heat treating at a temperature of 300 to 1000° C., preferably 700 to 950° C., the applying pressure comprises applying pressure at 0.1 to 200 megapascals, the time of the heat-treating and/or the applying pressure is 1 second to 24 hours, or a combination thereof.

Aspect 66. The method of any of aspects 61 to 65, wherein the first reduced iron is a first atomized iron, a first sponge iron powder, or a first direct reduced iron.

Aspect 67. The method of any of aspects 61 to 66, wherein the second iron material comprises an electrolytic iron, a carbonyl iron, an iron oxide, a second reduced iron, or a combination thereof, wherein the second reduced iron comprises a second atomized iron, a second direct reduced iron, a second sponge iron, or a combination thereof.

Aspect 68. The method of any of aspects 61 to 67, wherein the first blend comprises: 5 to 95 weight percent of the first iron material, and 5 to 95 weight percent of the second iron material, each based on a total weight of the first blend; preferably comprising 10 to 75 weight percent of the first iron material, and 25 to 90 weight percent of the second iron material, each based on a total weight of the first blend; and more preferably comprising 10 to 50 weight percent of the first iron material, and 50 to 90 weight percent of the second iron material, each based on a total weight of the first blend.

Aspect 69. The method of any of aspects 61 to 68, wherein the first iron material has a D50 particle size of less than 45 micrometers, 40 to 700 micrometers, preferably 120 to 450 micrometers.

Aspect 70. The method of any of aspects 61 to 69, wherein the first iron material has an apparent density of 0.5 to 3.5 grams per cubic centimeter, preferably 0.8 to 2.0 grams per cubic centimeter.

Aspect 71. The method of any of aspects 61 to 70, wherein the second iron material has a D50 particle size of 5 to 500 micrometers, preferably 20 to 400 micrometers.

Aspect 72. The method of any of aspects 61 to 71, wherein the second iron material has an apparent density of 0.5 to 4 grams per cubic centimeter.

Aspect 73. The method of any of aspects 61 to 72, wherein the second iron material comprises a second atomized iron powder, preferably water atomized iron, gas atomized iron, or granulated iron.

Aspect 74. The method of any of aspects 61 to 72, wherein the second iron material comprises an iron oxide, wherein a surface area of the first blend is 1 to 400 square meters per kilogram, 20 to 800 square meters per kilogram, 200 to 300 square meters per kilogram, or 1 to 200 square meters per kilogram, wherein a surface area of the second blend is 200 to 5000 square meters per kilogram, or 400 to 4000 square meters per kilogram.

Aspect 75. The method of aspect 74, wherein the iron oxide comprises hematite, magnetite, maghemite, wustite, martite, goethite, limonite, siderite, pyrite, ilmenite, spinel manganese ferrite, or a combination thereof.

Aspect 76. The method of any of aspects 61 to 72, wherein the second iron material comprises a second atomized iron, wherein the second iron material has a D50 particle size of 10 to 250 micrometers, preferably 20 to 150 micrometers, more preferably 25 to 70 micrometers; an apparent density of 0.5 to 3.8 grams per cubic centimeter, preferably 1.8 to 3.2 grams per cubic centimeter; or a combination thereof.

Aspect 77. The method of any of aspects 61 to 72, wherein the second iron material comprises a second reduced iron, wherein the second iron material has a D50 particle size of 5 to 500 micrometers, preferably 150 to 300 micrometers; an apparent density of 0.5 to 3.2 grams per cubic centimeter, preferably 0.5 to 1.8 grams per cubic centimeter; or a combination thereof.

Aspect 78. The method of any of aspects 61 to 72 or 74 to 75, wherein the second iron material comprises an iron oxide, wherein the iron oxide has a particle size of 10 to 500 micrometers, preferably 35 to 210 micrometers, more preferably 35 to 150 micrometers.

Aspect 79. The method of any of aspects 61 to 78, wherein the first blend further comprises an additive.

Aspect 80. The method of aspect 79, wherein the additive comprises copper, lead, bismuth, indium, tin, aluminum, an alloy thereof, or a combination thereof.

Aspect 81. The method of aspect 79 or 80, wherein the additive is present in an amount of 0.001 to 10 weight percent, preferably 0.1 to 5 weight percent, based on a total weight of the first blend.

Aspect 82. A method of forming an active material for an electrode, the method including providing an iron material and an additive, and forming the iron material and the additive into the active material, wherein the forming comprises atomizing the iron material and the additive.

Aspect 83. The method of aspect 82, wherein the atomizing comprises gas atomization, water atomization, granulation, or a combination thereof.

Aspect 84. The method of aspect 82, wherein the atomizing comprises gas atomization.

Aspect 85. The method of any of aspects 82 to 84, wherein the additive is present in an amount of 0.001 to 10 weight percent, preferably 0.01 to 5 weight percent, based on a total weight of the active material.

Aspect 86. The method of any of aspects 82 to 85, wherein the additive comprises lead, bismuth, indium, tin, aluminum, an alloy thereof, or a combination thereof.

Aspect 87. The method of any of aspects 82 to 86, wherein the iron material comprises iron ore, scrap iron, mill scale, pickle-liquor recovered iron, or a combination thereof.

Aspect 88. The method of any of aspects 82 to 87, wherein the active material has a D50 particle size of 5 to 500 micrometers, preferably 20 to 400 micrometers.

Aspect 89. The method of any of aspects 82 to 88, wherein the active material has an apparent density of 0.5 to 4 grams per cubic centimeter, 0.5 to 3.8 grams per cubic centimeter, 0.5 to 3.2 grams per cubic centimeter, 0.5 to 1.8 grams per cubic centimeter, 0.6 to 2.4 grams per cubic centimeter, 1.2 to 2.0 grams per cubic centimeter, or 1.8 to 3.2 grams per cubic centimeter.

Aspect 90. The method of any of aspects 82 to 89, wherein the active material further comprises a second iron material, wherein the second iron material is a second reduced iron.

Aspect 91. The method of aspect 90, wherein the second iron material is a second sponge iron or a second direct reduced iron.

Aspect 92. The method of aspect 90, wherein the second iron material comprises a second direct reduced iron.

Aspect 93. The method of any of aspects 90 to 92, wherein the active material comprises: 5 to 95 weight percent of the iron material, and 5 to 95 weight percent of the second iron material, each based on a total weight of iron in the active material; preferably comprising 10 to 75 weight percent of the iron material, and 25 to 90 weight percent of the second iron material, each based on a total weight of iron in the active material; and more preferably comprising 10 to 50 weight percent of the iron material, and 50 to 90 weight percent of the second iron material, each based on a total weight of iron in the active material.

Aspect 94. The method of any of aspects 90 to 93, wherein the second iron material has a D50 particle size of 5 to 500 micrometers, preferably 20 to 400 micrometers.

Aspect 95. The method of any of aspects 90 to 94, wherein the second iron material has an apparent density of 0.5 to 4 grams per cubic centimeter.

Aspect 96. The method of any of aspects 90 or 93 to 95, wherein the second iron material is a second atomized iron.

Aspect 97. The method of aspect 96, wherein the second atomized iron is water atomized iron, gas atomized iron, or granulated iron.

Aspect 98. The method of any of aspects 90 or 93 to 97, wherein the second iron material comprises a second atomized iron, wherein the second iron material has a D50 particle size of 5 to 250 micrometers, preferably 20 to 150 micrometers, more preferably 25 to 70 micrometers; an apparent density of 0.5 to 3.8 grams per cubic centimeter, or 1.8 to 3.2 grams per cubic centimeter; or a combination thereof.

Aspect 99. An electrochemical cell, including a first electrode; a second electrode; and an electrolyte disposed between the first electrode and the second electrode, wherein at least one of the first electrode or the second electrode comprises the active material prepared by the method of any of aspects 82 to 98.

Aspect 100. A method of forming an electrode, the method including providing an initial iron material having a first apparent density and a first surface area; oxidizing the initial iron material to form an oxidized iron material; reducing the oxidized iron material to form an iron material, wherein the iron material has a second apparent density and a second surface area, wherein the second apparent density is less than the first apparent density, and the second surface area is greater than the first surface area, and forming the iron material into the electrode.

Aspect 101. The method of aspect 100, wherein the first apparent density is 0.5 to 4.0 grams per cubic centimeter, and the first surface area is 1 to 400 square meters per kilogram.

Aspect 102. The method of aspect 100 or 101, wherein the second apparent density is 0.5 to 4.0 grams per cubic centimeter, 1.2 to 2.0 grams per cubic centimeter, 1.8 to 3.2 grams per cubic centimeter, or 0.5 to 1.8 grams per cubic centimeter, and the second surface area is 200 to 5000 square meters per gram, 20 to 800 square meters per gram, preferably 100 to 800 square meters per kilogram.

Aspect 103. The method of aspect 102, wherein the oxidizing comprises contacting with an aqueous salt solution, heating, steam treating, or a combination thereof.

Aspect 104. The method of aspect 103, wherein the contacting with an aqueous salt solution is for 1 to 96 hours, 12 to 96 hours, 24 to 96 hours, or 36 to 96 hours.

Aspect 105. The method of aspect 104, wherein the aqueous salt solution comprises sodium chloride, potassium chloride, lithium chloride, or a combination thereof.

Aspect 106. The method of aspect 103 or 104, wherein the aqueous salt solution contains sodium chloride, potassium chloride, lithium chloride, or a combination thereof at a concentration of 0.1 to 25 wt %, 0.5 to 15 wt %, or 0.1 to 10 wt %.

Aspect 107. The method of any of aspects 100 to 106, wherein the reducing comprises heating in the presence of a reducing agent, preferably wherein the reducing agent comprises hydrogen or carbon monoxide, more preferably hydrogen.

Aspect 108. The method of aspect 107, wherein the reducing is for 30 minutes to 6 hours, preferably 1 to 4 hours.

Aspect 109. The method of aspect 107 or 108, wherein the reducing is at a temperature of 400 to 1200° C., preferably 550 to 1100° C., more preferably 800 to 1100° C.

Aspect 110. The method of any of aspects 100 to 109, wherein the forming comprises atomizing the iron material.

Aspect 111. The method of aspect 110, wherein the atomizing comprises gas atomization.

Aspect 112. The method of aspect 110, wherein the atomizing comprises water atomization.

Aspect 113. The method of aspect 110, wherein the atomizing comprises granulation.

Aspect 114. The method of any of aspects 100 to 113, further comprising combining the iron material and an additive before the step of forming the electrode.

Aspect 115. The method of aspect 114, wherein the additive comprises lead, bismuth, indium, tin, aluminum, an alloy thereof, or a combination thereof.

Aspect 116. The method of any of aspects 100 to 115, wherein the initial iron material comprises a sponge iron, a direct reduced iron, an atomized iron, an electrolytic iron, a carbonyl iron, an iron oxide, or a combination thereof.

Aspect 117. The method of any of aspects 100 to 116, wherein the initial iron material has a D50 particle size of 10 to 500 micrometers.

Aspect 118. The method of any of aspects 100 to 117, wherein the iron material has a D50 particle size of 10 to 500 micrometers.

Aspect 119. The method of any of aspects 100 to 118, further comprising combining the iron material with a second iron material before the step of forming the electrode, wherein the second iron material is different from the iron material.

Aspect 120. The method of aspect 119, wherein the second iron material comprises an electrolytic iron, a carbonyl iron, an iron oxide, a second reduced iron, or a combination thereof, wherein the second reduced iron comprises a second atomized iron, a second direct reduced iron, a second sponge iron, or a combination thereof.

Aspect 121. The method of aspect 120, wherein the electrode comprises: 5 to 95 weight percent of the iron material, and 5 to 95 weight percent of the second iron material, each based on a total weight of the electrode; preferably comprising 10 to 75 weight percent of the iron material, and 25 to 90 weight percent of the second iron material, each based on a total weight of the electrode; and more preferably comprising 10 to 50 weight percent of the iron material, and 50 to 90 weight percent of the second iron material, each based on a total weight of the electrode.

Aspect 122. The method of aspect 120 or 121, wherein the second iron material has a D50 particle size of 5 to 500 micrometers.

Aspect 123. The method of any of aspects 120 to 122, wherein the second iron material has an apparent density of 0.5 to 4 grams per cubic centimeter.

In any of the foregoing aspects,
the first reduced iron may be a first atomized iron, a first sponge iron, or a first direct reduced iron;
the second iron material may comprise an electrolytic iron, a carbonyl iron, an iron oxide, a second reduced iron, or a combination thereof, wherein the second reduced iron may comprise a second atomized iron, a second direct reduced iron, or a combination thereof;
the electrode, the first electrode, the second electrode, the blend, active material, or composition may comprise 5 to 95 wt % of the first iron material, and 5 to 95 wt % of the second iron material, each based on a total weight of the electrode; preferably comprising 10 to 75 wt % of the first iron material, and 25 to 90 wt % of the second iron material, each based on a total weight of the electrode; and more preferably comprising 10 to 50 wt % of the first iron material, and 50 to 90 wt % of the second iron material, each based on a total weight of the electrode;
the first iron material may have a D50 particle size of less than 45 micrometers, 40 to 700 micrometers, preferably 120 to 450 micrometers;
the first iron material may comprise a first sponge iron or a first direct reduced iron having an apparent density of 0.5 to 3.5 grams per cubic centimeter, preferably 0.8 to 2.0 grams per cubic centimeter;
the first iron material may comprise a first atomized iron having an apparent density of 0.5 to 4.0 grams per cubic centimeter, 1.5 to 3.8 grams per cubic centimeter, or preferably 0.8 to 3.2 grams per cubic centimeter;
the second iron material may have a D50 particle size of 5 to 500 micrometers, 5 to 250 micrometers, 50 to 150 micrometers, preferably 10 to 500 micrometers, or 20 to 400 micrometers;
the first iron material may have a D50 particle size of less than 45 micrometers, 10 to 45 micrometers, 20 to 45 micrometers, or 25 to 45 micrometers, and the second iron material may have a D50 particle size of 5 to 500 micrometers, 50 to 500 micrometers, or preferably 20 to 400 micrometers;
the second iron material may have an apparent density of 0.5 to 4 grams per cubic centimeter or 1.5 to 3.8 grams per cubic centimeter;
the second iron material may be a second sponge iron or a second direct reduced iron;
the second iron material may comprise a second direct reduced iron;
the second iron material may be a second atomized iron;
the second atomized iron may be water atomized iron, gas atomized iron, or granulated iron;
the second iron material may comprise an iron oxide;
the iron oxide may comprise hematite, magnetite, maghemite, wustite, martite, goethite, limonite, siderite, pyrite, ilmenite, spinel manganese ferrite, or a combination thereof;
the second iron material may comprise a second atomized iron, wherein the second iron material has a D50 particle size of 10 to 250 micrometers, preferably 20 to 150 micrometers, more preferably 25 to 70 micrometers; an apparent density of 0.5 to 3.8 grams per cubic centimeter, preferably 1.8 to 3.2 grams per cubic centimeter; or a combination thereof;
the second iron material may comprise a second reduced iron, wherein the second iron material has a D50 particle size of 5 to 500 micrometers, preferably 150 to 300 micrometers, 10 to 250 micrometers, or 20 to 150 micrometers, or 25 to 70 micrometers, or 35 to 210 micrometers, or 35 to 90 micrometers; an apparent density of 0.5 to 3.5 grams per cubic centimeter, preferably 0.5 to 1.8 grams per cubic centimeter; or a combination thereof; or an apparent density of 1.5 to 3.8 grams per cubic centimeter, preferably 1.8 to 3.2 grams per cubic centimeter;
the second iron material may comprise an iron oxide, wherein the iron oxide has a D50 particle size of 10 to 500 micrometers, preferably 35 to 210 micrometers, more preferably 35 to 150 micrometers;
optionally the electrode, the first electrode, the second electrode, the blend, or composition may further comprise an additive;
the additive may comprise copper, lead, bismuth, indium, tin, aluminum, an alloy thereof, or a combination thereof;
the additive may be present in an amount of 0.001 to 10 wt %, preferably 0.1 to 5 wt %, based on a total weight of the electrode;
optionally further comprising a third iron material, wherein the third iron material is different from the first iron material and the second iron material;
the third iron material may comprise an electrolytic iron, a carbonyl iron, an iron oxide, a third reduced iron, or a combination thereof, wherein the third reduced iron may comprise a third atomized iron, a third direct reduced iron, or a combination thereof;
optionally wherein the electrode or composition comprises 5 to 90 wt % of the first iron material, 5 to 90 wt % of the second iron material, and 5 to 90 wt % of the third iron material, each based on a total weight of the electrode; preferably comprising 10 to 70 wt % of the first iron material, 15 to 80 wt % of the second iron material, and 15 to 80 wt % of the third iron material, each based on a total weight of the electrode; and more preferably comprising 10 to 50 wt % of the first iron material, 25 to 75 wt % of the second iron material, and 25 to 75 wt % of the third iron material, each based on a total weight of the electrode;
the third iron material may have a D50 particle size of 5 to 850 micrometers;
the third iron material may have an apparent density of 0.5 to 4 grams per cubic centimeter;
the third iron material may be a third atomized iron, wherein the third atomized iron may be water atomized iron, gas atomized iron, or granulated iron;
the third iron material may comprise a second iron oxide, wherein the second iron oxide may comprise hematite, magnetite, maghemite, wustite, martite, goethite, limonite, siderite, pyrite, ilmenite, spinel manganese ferrite, or a combination thereof;
optionally further comprising an additive, wherein the additive may comprise copper, lead, bismuth, indium, tin, aluminum, an alloy thereof, or a combination thereof, and wherein the additive may be present in an amount of 0.001 to 10 wt %, preferably 0.1 to 5 wt %, based on a total weight of the electrode;
wherein the first reduced iron may be a first atomized iron and the second iron material may be an iron oxide, the first reduced iron may be a first atomized iron and the second iron material may be a second atomized iron, the first reduced iron may be a first sponge iron and the second iron material may be a second atomized iron, or the first reduced iron may be a first sponge iron and the second iron material may be an iron oxide;
wherein the electrode or composition may comprise: a sponge iron, an atomized iron, and an iron oxide; a sponge iron, an iron oxide, and an additive; a first sponge iron, a second sponge iron, and a third atomized iron, wherein the first sponge iron is different from the second sponge iron; a first sponge iron, a second sponge iron, and a second iron oxide, wherein the first sponge iron is different from the second sponge iron; a first sponge iron, a second atomized iron, and a third atomized iron, wherein the second atomized iron is different from the third atomized iron; or a first sponge iron, a first iron oxide, and a second iron oxide, wherein the first iron oxide is different from the second iron oxide;
the first reduced iron may be a sponge iron or a direct reduced iron;
the first electrode may comprise the first iron material and the second iron material, and a discharge capacity after a twenty-fifth cycle of the electrochemical cell may be greater than a discharge capacity of a comparative electrochemical cell that comprises a first electrode comprising the first iron material and without the second iron material;
the electrolyte may comprise an aqueous solution of an alkali hydroxide, an organic hydroxide, or a combination thereof;
the alkali hydroxide, the organic hydroxide, or the combination thereof may be present in the aqueous solution in an amount from 20 to 50 weight percent, based on a total weight of the electrolyte;
the second electrode may comprise carbon, titanium, lead, nickel, platinum, iridium, ruthenium, tantalum, niobium, zirconium, vanadium, hafnium, aluminum, cobalt, antimony, tungsten, an alloy thereof, an oxide thereof, or a combination thereof;
optionally further comprising a third electrode;
wherein the electrochemical cell may comprise an iron electrode in contact with an anode current collector; an oxygen reduction reaction electrode having a first surface facing the iron electrode and an opposing second surface in contact with air; and an oxygen evolution reaction electrode, wherein the electrolyte is in contact with the iron electrode, the first surface of the oxygen reduction reaction electrode, and the oxygen evolution reaction electrode;
optionally further comprising a separator disposed between at least a portion of the iron electrode and the oxygen evolution reaction electrode;
wherein the forming may comprise applying pressure and/or heat to the blend for a time to form the electrode;
wherein the pressure and/or heat may be applied by isostatic pressing, uniaxial pressing, roll compaction, briquetting, forging, or a combination thereof;
wherein the applying heat is heat treating at a temperature of 300 to 1000° C., preferably 700 to 950° C., the applying pressure is applying pressure at 0.1 to 200 MPa, the time of the heat-treating and/or the applying pressure is 1 second to 24 hours, or a combination thereof;
the atomizing may comprise gas atomization, water atomization, granulation, or a combination thereof, preferably gas atomization;
the iron material may comprise iron ore, scrap iron, mill scale, pickle-liquor recovered iron, or a combination thereof;
the active material may have a D50 particle size of 5 to 500 micrometers., preferably 20 to 400 micrometers;
the active material may have an apparent density of 0.5 to 4 grams per cubic centimeter, 0.5 to 3.8 grams per cubic centimeter, 0.5 to 3.2 grams per cubic centimeter, 0.5 to 1.8 grams per cubic centimeter, 0.6 to 2.4 grams per cubic centimeter, 1.2 to 2.0 grams per cubic centimeter, or 1.8 to 3.2 grams per cubic centimeter;
the active material may further comprise a second iron material, wherein the second iron material is a second reduced iron;
the initial iron material or first iron material may have a first apparent density of 0.5 to 4.0 g/cc, and a first surface area of 1 to 400 m²/kg;
the iron material may have a second apparent density of 0.5 to 4.0 g/cc, 1.2 to 2.0 g/cc, 1.8 to 3.2 g/cc, or 0.5 to 1.8 g/cc, and a second surface area may be 200 to 5000 m²/kg, 20 to 800 m²/kg, preferably 100 to 800 m²/kg;
the oxidizing may comprise contacting with an aqueous salt solution, heating, steam treating, or a combination thereof;
the contacting with an aqueous salt solution may be for 1 to 96 hours, 12 to 96 hours, 24 to 96 hours, or 36 to 96 hours;
the aqueous salt solution may comprise sodium chloride, potassium chloride, lithium chloride, or a combination thereof;
the reducing may comprise heating in the presence of a reducing agent, preferably wherein the reducing agent comprises hydrogen or carbon monoxide, more preferably hydrogen;
the reducing may be for 30 minutes to 6 hours, preferably 1 to 4 hours;
the reducing may comprise reducing at a temperature of 400 to 1200° C., preferably 550 to 1100° C., more preferably 800 to 1100° C.;
the forming may comprise atomizing the iron material;
optionally further comprising combining the iron material and an additive before the forming the electrode;
the initial iron material may comprise sponge iron, direct reduced iron, atomized iron, electrolytic iron, carbonyl iron, an iron oxide, or a combination thereof.
the initial iron material may have a D50 particle size of 10 to 500 micrometers;
the iron material may have a D50 particle size of 10 to 500 micrometers; or
optionally further comprising combining the iron material with a second iron material before the step of forming the electrode, wherein the second iron material is different from the iron material.

The compositions, methods, and articles can alternatively comprise, consist of, or consist essentially of, any appropriate materials, steps, or components herein disclosed. The compositions, methods, and articles can additionally, or alternatively, be formulated so as to be devoid, or substantially free, of any materials (or species), steps, or components, which are otherwise not necessary to the achievement of the function or objectives of the compositions, methods, and articles.

All ranges disclosed herein are inclusive of the endpoints, and the endpoints are independently combinable with each other (e.g., ranges of “up to 25 wt %, or, more specifically, 5 wt % to 20 wt %”, is inclusive of the endpoints and all intermediate values of the ranges of “5 wt % to 25 wt %,” etc.). “Combinations” is inclusive of blends, mixtures, alloys, reaction products, and the like. The terms “first,” “second,” and the like, do not denote any order, quantity, or importance, but rather are used to distinguish one element from another. The terms “a” and “an” and “the” do not denote a limitation of quantity and are to be construed to cover both the singular and the plural, unless otherwise indicated herein or clearly contradicted by context. “Or” means “and/or” unless clearly stated otherwise. Reference throughout the specification to “some embodiments,” “an embodiment,” “an aspect,” and so forth, means that a particular element described in connection with the embodiment and/or aspect is included in at least one embodiment and/or aspect described herein, and may or may not be present in other embodiments and/or aspects. In addition, it is to be understood that the described elements may be combined in any suitable manner in the various embodiments and/or aspects. A “combination thereof” is open and includes any combination comprising at least one of the listed components or properties optionally together with a like or equivalent component or property not listed.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this application belongs. All cited patents, patent applications, and other references are incorporated herein by reference in their entirety. However, if a term in the present application contradicts or conflicts with a term in the incorporated reference, the term from the present application takes precedence over the conflicting term from the incorporated reference.

While particular embodiments have been described, alternatives, modifications, variations, improvements, and substantial equivalents that are or may be presently unforeseen may arise to applicants or others skilled in the art. Accordingly, the appended claims as filed and as they may be amended are intended to embrace all such alternatives, modifications variations, improvements, and substantial equivalents.

What is claimed is:

1. An electrode, comprising:
a first iron material, wherein the first iron material is a first reduced iron; and
a second iron material that is different from the first iron material.

2. The electrode of claim 1, wherein the first reduced iron is a first atomized iron, a first sponge iron, or a first direct reduced iron;
wherein the second iron material comprises an electrolytic iron, a carbonyl iron, an iron oxide, a second reduced iron, or a combination thereof, wherein the second reduced iron comprises a second atomized iron, a second direct reduced iron, a second sponge iron, or a combination thereof; or
a combination thereof.

3. The electrode of claim 1, comprising:
5 to 95 weight percent of the first iron material, and 5 to 95 weight percent of the second iron material, each based on a total weight of the electrode.

4. The electrode of claim 1,
wherein the first iron material has a D50 particle size of less than 45 micrometers;
wherein the first iron material comprises a first sponge iron or a first direct reduced iron and has an apparent density of 0.5 to 3.5 grams per cubic centimeter;
wherein the first iron material comprises a first atomized iron and has an apparent density of 0.5 to 4 grams per cubic centimeter;
wherein the second iron material has a D50 particle size of 5 to 500 micrometers;
wherein the first iron material has a D50 particle size of less than 45 micrometers and the second iron material has a D50 particle size of 5 to 500 micrometers;
wherein the second iron material has an apparent density of 0.5 to 4 grams per cubic centimeter; wherein the second iron material is a second atomized iron; wherein the first atomized iron is water atomized iron, gas atomized iron, or granulated iron and wherein the second atomized iron is water atomized iron, gas atomized iron, or granulated iron; or
wherein the second iron material comprises an iron oxide.

5. The electrode of claim 4, wherein the iron oxide comprises hematite, magnetite, maghemite, wustite, martite, goethite, limonite, siderite, pyrite, ilmenite, spinel manganese ferrite, or a combination thereof.

6. The electrode of claim 1, wherein the second iron material comprises a second atomized iron, wherein the second iron material has
a D50 particle size of 10 to 250 micrometers;
an apparent density of 0.5 to 3.8 grams per cubic centimeter; or
a combination thereof.

7. The electrode of claim 1, wherein the second iron material comprises a second reduced iron, wherein the second iron material has
a D50 particle size of 5 to 500 micrometers;
an apparent density of 0.5 to 3.2 grams per cubic centimeter; or
a combination thereof.

8. The electrode of claim 1, wherein the second iron material comprises an iron oxide, wherein the iron oxide has a D50 particle size of 10 to 500 micrometers.

9. The electrode of claim 1, further comprising an additive.

10. The electrode of claim 9, wherein the additive comprises copper, lead, bismuth, indium, tin, aluminum, an alloy thereof, or a combination thereof;
wherein the additive is present in an amount of 0.001 to 10 weight percent based on a total weight of the electrode; or
a combination thereof.

11. The electrode of claim 1, wherein:
the first reduced iron is a first atomized iron and the second iron material is an iron oxide;
the first reduced iron is a first atomized iron and the second iron material is a second atomized iron;
the first reduced iron is a first sponge iron and the second iron material is a second atomized iron; or
the first reduced iron is a first sponge iron and the second iron material is an iron oxide.

12. The electrode of claim 1, further comprising a third iron material, wherein the third iron material is different from the first iron material and the second iron material.

13. The electrode of claim 12, wherein the third iron material comprises an electrolytic iron, a carbonyl iron, a second iron oxide, a third reduced iron, or a combination thereof, wherein the third reduced iron comprises a third atomized iron, a third direct reduced iron, or a combination thereof.

14. The electrode of claim 12, comprising:
5 to 90 weight percent of the first iron material, 5 to 90 weight percent of the second iron material, and 5 to 90 weight percent of the third iron material, each based on a total weight of the electrode.

15. The electrode of claim 12,
wherein the third iron material has a D50 particle size of 5 to 850 micrometers;
wherein the third iron material has an apparent density of 0.5 to 4 grams per cubic centimeter;
wherein the third iron material is a third atomized iron;
wherein the third atomized iron is water atomized iron, gas atomized iron, or granulated iron; or
wherein the third iron material comprises a second iron oxide.

16. The electrode of claim 15, wherein the second iron oxide comprises hematite, magnetite, maghemite, wustite, martite, goethite, limonite, siderite, pyrite, ilmenite, spinel manganese ferrite, or a combination thereof.

17. The electrode of claim 12, wherein the electrode comprises:
a sponge iron, an atomized iron, and an iron oxide;
a sponge iron, an iron oxide, and an additive;
a first sponge iron, a second sponge iron, and a third atomized iron, wherein the first sponge iron is different from the second sponge iron;
a first sponge iron, a second sponge iron, and a second iron oxide, wherein the first sponge iron is different from the second sponge iron;
a first sponge iron, a second atomized iron, and a third atomized iron, wherein the second atomized iron is different from the third atomized iron; or
a first sponge iron, a first iron oxide, and a second iron oxide, wherein the first iron oxide is different from the second iron oxide.

18. An electrochemical cell, comprising:
a first electrode;
a second electrode; and
an electrolyte disposed between the first electrode and the second electrode,
wherein at least one of the first electrode or the second electrode comprises:
a first iron material, wherein the first iron material is a first reduced iron; and
a second iron material that is different from the first iron material,
optionally wherein the first electrode is prepared from a composition comprising the first iron material, the second electrode is prepared from a composition comprising the second iron material, or both.

19. The electrochemical cell of claim 18, wherein the at least one of the first electrode or the second electrode comprises:
5 to 95 weight percent of the first iron material, and 5 to 95 weight percent of the second iron material, each based on a total weight of the electrode.

20. The electrochemical cell of claim 18, wherein at least one of the first electrode or the second electrode further comprises an additive.

21. The electrochemical cell of claim 18, wherein
the first electrode comprises the first iron material and the second iron material,
a discharge capacity during a fifth to twentieth cycle of the electrochemical cell is substantially the same as a discharge capacity of a comparative electrochemical cell that comprises a first electrode comprising the first iron material and without the second iron material.

22. The electrochemical cell of claim 18, wherein
the first electrode comprises the first iron material and the second iron material,
a discharge capacity after a twenty-fifth cycle of the electrochemical cell is greater than a discharge capacity of a comparative electrochemical cell that comprises a first electrode comprising the first iron material and without the second iron material.

23. The electrochemical cell of claim 18, wherein the electrolyte comprises an aqueous solution of an alkali hydroxide, an organic hydroxide, or a combination thereof.

24. The electrochemical cell of claim 23, wherein the alkali hydroxide, the organic hydroxide, or the combination thereof is present in the aqueous solution in an amount from 20 to 50 weight percent, based on a total weight of the electrolyte.

25. The electrochemical cell of claim 18, wherein the second electrode comprises carbon, titanium, lead, nickel, platinum, iridium, ruthenium, tantalum, niobium, zirconium, vanadium, hafnium, aluminum, cobalt, antimony, tungsten, an alloy thereof, an oxide thereof, or a combination thereof.

26. The electrochemical cell of claim 18, further comprising a third electrode.

27. The electrochemical cell of claim 26, comprising:
an iron electrode in contact with an anode current collector;
an oxygen reduction reaction electrode having a first surface facing the iron electrode and an opposing second surface in contact with air; and
an oxygen evolution reaction electrode,
wherein the electrolyte is in contact with the iron electrode, the first surface of the oxygen reduction reaction electrode, and the oxygen evolution reaction electrode.

28. The electrochemical cell of claim 27, further comprising a separator disposed between at least a portion of the iron electrode and the oxygen evolution reaction electrode.

29. A method of preparing an electrode, the method comprising:
providing a first blend of a first iron material and a second iron material, wherein the first iron material is a first reduced iron, and the second iron material that is different from the first iron material; and
forming the first blend to provide the electrode comprising a second blend,
wherein a surface area of the first blend is less than a surface area of the second blend.

30. The method of claim 29, wherein the forming of the first blend is performed in a reducing atmosphere; wherein the forming comprises applying pressure and/or heat to the first blend for a time to form the electrode; or
a combination thereof.

31. The method of claim 30, wherein the pressure and/or heat are applied by isostatic pressing, uniaxial pressing, roll compaction, briquetting, forging, or a combination thereof.

32. The method of claim 30, wherein
the applying heat comprises heat treating at a temperature of 300 to 1000° C.,
the applying pressure comprises applying pressure at 0.1 to 200 megapascals,
the time of the heat-treating and/or the applying pressure is 1 second to 24 hours, or
a combination thereof.

33. The method of claim 29, wherein the first blend comprises:
5 to 95 weight percent of the first iron material, and 5 to 95 weight percent of the second iron material, each based on a total weight of the first blend.

34. The method of claim 29, wherein the second iron material comprises an iron oxide, wherein a surface area of the first blend is 1 to 400 square meters per kilogram, wherein a surface area of the second blend is 200 to 5000 square meters per kilogram.

35. The method of claim 29, wherein the first blend further comprises an additive.

36. A method of forming an active material for an electrode, the method comprising:
providing an iron material and an additive, and
forming the iron material and the additive into the active material,
wherein the forming comprises atomizing the iron material and the additive.

37. The method of claim 36, wherein the atomizing comprises gas atomization, water atomization, granulation, or a combination thereof.

38. The method of claim 36, wherein the iron material comprises iron ore, scrap iron, mill scale, pickle-liquor recovered iron, or a combination thereof;
wherein the active material has a D50 particle size of 5 to 500 micrometers;
wherein the active material has an apparent density of 0.5 to 4 grams per cubic centimeter; or
a combination thereof.

39. The method of claim 36, wherein the active material further comprises a second iron material, wherein the second iron material is a second reduced iron.

40. The method of claim 39, wherein the second iron material is a second sponge iron or a second direct reduced iron.

41. The method of claim 39, wherein the active material comprises:
5 to 95 weight percent of the iron material, and 5 to 95 weight percent of the second iron material, each based on a total weight of iron in the active material

42. The method of claim 39, wherein the second iron material has a D50 particle size of 5 to 500 micrometers; wherein the second iron material has an apparent density of 0.5 to 4 grams per cubic centimeter;
wherein the second iron material is a second atomized iron; or
a combination thereof.

43. The method of claim 42, wherein the second atomized iron is water atomized iron, gas atomized iron, or granulated iron.

44. The method of claim 39, wherein the second iron material comprises a second atomized iron, wherein the second iron material has
a D50 particle size of 5 to 250 micrometers;
an apparent density of 0.5 to 3.8 grams per cubic centimeter; or
a combination thereof.

45. An electrochemical cell, comprising:
a first electrode;
a second electrode; and
an electrolyte disposed between the first electrode and the second electrode,
wherein at least one of the first electrode or the second electrode comprises the active material prepared by the method of claim 36.

46. A method of forming an electrode, the method comprising:
providing an initial iron material having a first apparent density and a first surface area;
oxidizing the initial iron material to form an oxidized iron material;
reducing the oxidized iron material to form an iron material, wherein the iron material has a second apparent density and a second surface area,
wherein the second apparent density is less than the first apparent density, and the second surface area is greater than the first surface area, and
forming the iron material into the electrode.

47. The method of claim 46, wherein the first apparent density is 0.5 to 4.0 grams per cubic centimeter, and the first surface area is 1 to 400 square meters per kilogram.

48. The method of claim 46, wherein the second apparent density is 0.5 to 4.0 grams per cubic centimeter, and the second surface area is 200 to 5000 square meters per gram.

49. The method of claim 46, wherein the oxidizing comprises contacting with an aqueous salt solution, heating, steam treating, or a combination thereof.

50. The method of claim 49, wherein the contacting with an aqueous salt solution is for 1 to 96 hours.

51. The method of claim 49, wherein the aqueous salt solution comprises sodium chloride, potassium chloride, lithium chloride, or a combination thereof; or wherein the aqueous salt solution contains sodium chloride, potassium chloride, lithium chloride, or a combination thereof at a concentration of 0.1 to 25 weight percent.

52. The method of claim 46,
wherein the reducing comprises heating in the presence of a reducing agent
wherein the reducing is for 30 minutes to 6 hours;
wherein the reducing is at a temperature of 400 to 1200° C.;
wherein the forming comprises atomizing the iron material; or
combination thereof.

53. The method of claim 52, wherein the atomizing comprises gas atomization, water atomization, or granulation.

54. The method of claim 46, further comprising combining the iron material and an additive before the step of forming the electrode.

55. The method of claim 54, wherein the additive comprises lead, bismuth, indium, tin, aluminum, an alloy thereof, or a combination thereof.

56. The method of claim 46, wherein the initial iron material comprises a sponge iron, a direct reduced iron, an atomized iron, an electrolytic iron, a carbonyl iron, an iron oxide, or a combination thereof.

57. The method of claim 46, wherein the initial iron material has a D50 particle size of 10 to 500 micrometers.

58. The method of claim 46, wherein the iron material has a D50 particle size of 10 to 500 micrometers.

59. The method of claim 46, further comprising combining the iron material with a second iron material before the step of forming the electrode, wherein the second iron material is different from the iron material.

60. The method of claim 59, wherein the second iron material comprises an electrolytic iron, a carbonyl iron, an iron oxide, a second reduced iron, or a combination thereof, wherein the second reduced iron comprises a second atomized iron, a second direct reduced iron, a second sponge iron, or a combination thereof.
